(19) United States
(12) Patent Application Publication
(10) Pub. No.: US 2018/0275437 A1
(43) Pub. Date: Sep. 27, 2018

(54) DISPLAY PANEL AND METHOD OF PRODUCING DISPLAY PANEL

(71) Applicant: SHARP KABUSHIKI KAISHA, Sakai City, Osaka (JP)

(72) Inventors: SHOGO NISHIWAKI, Sakai City (JP); MASAHIKO KONDOH, Sakai City (JP)

(21) Appl. No.: 15/755,554

(22) PCT Filed: Aug. 26, 2016
(86) PCT No.: PCT/JP2016/074945

§ 371 Date: Feb. 27, 2018

(30) Foreign Application Priority Data
Aug. 31, 2015 (JP) 2015-170391

(51) Int. Cl. G02F 1/1339; G02F 1/1335

(52) U.S. Cl. CPC G02F 1/1339; G02F 2001/133357; G02F 1/133512

(57) ABSTRACT

A method of producing a liquid crystal panel 11 (a display panel) includes: a sealing member forming process of forming a sealing member 11q; a board bonding process of bonding an array board 11b (a second board) to the CF board 11a with a liquid crystal layer 11c (a medium layer) between the array board 11b and the CF board 11a; and a sealing member fixing process of fixing the sealing member 11q to the array board 11b. The sealing member forming process includes disposing a sealing material S on the CF board 11a and curing the sealing member 11q without any uncured section.

### TECHNICAL FIELD

The present invention relates to a display panel and a method of producing a display panel.

### BACKGROUND ART

A method of producing a liquid crystal panel of a liquid crystal display device disclosed in Patent Document 1 has been known as an example of a method of producing a liquid crystal panel. According to the method of producing the liquid crystal panel disclosed in Patent Document 1, a recess is formed for an entire peripheral area of an alignment film forming area on a substrate. A first application liquid is applied on the recess to form a bank portion in a frame shape. A second application liquid is discharged to the alignment film forming area through an inkjet method to form an alignment film. A sealing member is disposed on one of the substrates including the substrate on which the alignment film is formed. The substrates are bonded together with the sealing member. A liquid crystal layer is sandwiched between the substrates. An outer edge of the sealing member is located closer to an outer edge of the substrate relative to the bank portion.

### RELATED ART DOCUMENT

### Patent Document

Patent Document 1: Unexamined Japanese Patent Application Publication No. 2014-174432

### Problem to be Solved by the Invention

Patent Document 1 includes two problems described below. A first problem will be described. In Patent Document 1, bonding of boards is performed after a sealant that has not been cured is applied and then the sealant is cured. During the bonding of the boards, a liquid crystal material is pressed and spread between the boards. The sealant receives a force that is applied to the sealant by the liquid crystal material to push the sealant. If the frame size of the liquid crystal panel is further reduced and a width of the sealant is reduced, the sealant may not be able to withstand the force and the liquid crystal material may partially enter the sealant. Furthermore, if the frame size of the liquid crystal panel is further reduced and a width of a seal member is reduced, external moisture may passes through an uncured section of the sealant and tend to diffused in a liquid crystal layer.

Next, a second problem will bP described. In Patent Document 1, the sealant is disposed to overlap a peripheral light blocking portion. To cure and fix the sealant to a common board, ultraviolet rays are applied from the array board side to cure the sealant. In recent years, a number of traces are disposed in a frame area of the array board. The traces may overlap the sealant. In such a case, the ultraviolet rays are applied to the sealant through spaces between the traces. If the frame size of the liquid crystal panel is further reduced, an arrangement area of the traces is reduced. Therefore, arrangement density of the traces increases and the spaces between the traces decreases. During curing of the sealant, the ultraviolet rays may be blocked by the traces and thus curing of the sealant may become difficult or a longer period of time may be required for curing the sealant.

### DISCLOSURE OF THE PRESENT INVENTION

The present invention was made in view of the above circumstances. An object is to provide a liquid crystal panel and a method of producing the liquid crystal panel preferable for a reduction in frame size.

### Means for Solving the Problem

A method of producing a display panel according to the present invention includes a sealing member forming process of forming a sealing member, a board bonding process of bonding a second board to a first board with a medium layer between the first board and the second board, and a sealing member fixing process of fixing the sealing member to the second board. The sealing member forming process includes disposing a sealing material on the first board and curing the sealing material without any uncured section.

In the sealing member forming process, the sealing material is disposed on the first board and the sealing material is cured without any uncured section. Through the process, the sealing member is formed. In the board bonding process that is subsequently performed, the second board is bonded to the first board with the medium layer between the first board and the second board. In the sealing member fixing process that is subsequently performed, the sealing member is fixed to the second board. Through the process, the medium layer is sealed. In the board bonding process, the medium layer is pressed and spread between the boards in accordance with the bonding of the boards. The sealing member receives a force that may be applied by the medium layer to push the sealing member. If the frame size is further reduced and the width of the sealing member is reduced, the sealing member may not be able to withstand the force and the medium layer may partially enter into the sealing member. In the sealing member forming process that is preformed prior to the board bonding process, the sealing material is cured without any uncured section to form the sealing member. Therefore, even if the frame size is further reduced, the medium layer is less likely to partially enter into the sealing member. If the width of the sealing member is reduced in accordance with the further reduction in the frame size, external moisture may pass through the uncured section of the sealing member and diffuse in the medium layer. In the sealing member forming process that is preformed prior to the board bonding process, the sealing material is cured without any uncured section to form the sealing member. Therefore, even if the frame size is further reduced, the external moisture is less likely to pass through the sealing member and thus the moisture is less likely to diffuse in the medium layer. As described above, this method is preferable for reducing the frame size of the display panel.

Preferable embodiments of the method of producing the display panel according to the present invention may include the following features.

(1) The method may further include a first base board producing process, a second base board producing process, a base sealing material disposing process, and a base sealing material curing process. The first base board producing process includes producing a first base board including first boards within a plate surface of the first base board. The second base board producing process includes producing a second base board including second boards within a plate surface of the second base board. The base sealing material disposing process includes disposing a base sealing material on any one of the first base board and the second base board to surround either the first boards or the second boards and to include an uncured section. The base sealing material curing process includes curing the base sealing material without any uncured section to form a base sealing member. The base sealing material curing process is performed after at least the board bonding process. In the base sealing material disposing process, the base sealing material that includes the uncured section is disposed on any one of the first base board that is produced through the first base board producing process and the second base board that is produced through the second base board producing process to surround either the first board or the second boards. In the board bonding process that is subsequently performed, the boards are bonded together. The base sealing material that includes the uncured section closely contacts the other one of the first base board and the second base board. The boards are maintained under negative pressure. Therefore, the boards are less likely to be displaced or removed. In the base sealing material curing process that is subsequently performed, the base sealing material is cured without any uncured section. Through the process, the base sealing member is formed.

(2) The base sealing material disposing process may include disposing the base sealing material on the second base board. The base sealing material disposing process is performed to dispose the base sealing material on the second base board that is not the first base board on which the sealing member forming process is performed. Therefore, the sealing member forming process and the base sealing material disposing process can be performed in parallel. In comparison to the method in which the sealing member forming process and the base sealing material disposing process are performed on the first base board, time that is required for the production of the display panel can be reduced.

(3) The medium layer in the board bonding process may be a liquid crystal layer. The base sealing material disposing process may include disposing a thermosetting resin material as the base sealing material. The base sealing curing process may include heating processing that is performed until a temperature reaches at least a curing temperature of the thermosetting resin material. When the heating processing is performed until the temperature reaches at least the curing temperature of the thermosetting resin material in the base sealing material curing process, the thermosetting resin material is cured and the base sealing member is formed. Furthermore, reorientation of liquid crystal molecules included in the liquid crystal layer that is the medium layer is accelerated. Therefore, the liquid crystal molecules included in the liquid crystal layer are properly orientated.

(4) The sealing member forming process may include discharging the sealing material by a dispenser and disposing the sealing material along an area to form the sealing member. In comparison to a method in which the sealing material is layered in an entire area of the plate surface of the first board and the sealing material is selectively cured, an amount of the sealing material can be reduced. This method is preferable for reducing the production cost.

(5) The sealing member forming process may include a sealing material disposing process and a sealing material curing process. The sealing material disposing process may include disposing the sealing material that is in a powdered form on the first board. The sealing material curing process may include applying a laser beam to a section of the sealing material and selectively curing the section of the sealing material without any cured area. In the sealing material disposing process, the sealing material that is in the powder form is disposed on the first board. In the sealing material curing process that is subsequently performed, the laser beam is applied to the sealing material that is disposed on the first board and the section to which the laser beam is applied is selectively cured without any uncured area. Through the processes, the sealing member is formed.

(6) The sealing member forming process may include heating and fusing the sealing material that is the thermosetting resin material, applying the sealing material to the first board, and curing the sealing material without any uncured section. In the sealing member forming process, after the sealing material is heated and fused, the fused sealing material is applied to the first board. The sealing material that is applied to the first board is cured without any uncured section as the temperature decreases. Through the process, the sealing member is formed.

A display panel according to the present invention includes pixels, an array board, a common board, a medium layer, and a sealing member. The pixels are arranged in a matrix in a display area in which an image is displayed. The array board includes at least traces that are disposed in a non-display area outside the display area. The common board is disposed opposite the array board. The common board includes a light blocking portion. The light blocking portion includes sections that are disposed to separate at least the pixels from one another. The medium layer is sandwiched between the array board and the common board. The sealing member is disposed between the array board and the common board to overlap the traces in the non-display area to surround the medium layer. The sealing member is made of a material having a light blocking property and disposed not to overlap the light blocking portion.

Because the pixels that are arranged in the matrix in the display area are separated from one another by the light blocking portion, color mixture is less likely to occur. The medium layer that is sandwiched between the array board and the common board is sealed with the sealing member that is disposed between the array board and the common board in the non-display area to surround the medium layer.

The sealing member is disposed to overlap the traces that are included in the array board in the non-display area. To accelerate the fixation of the sealing member to the common board with light applied from the array board side, the light may be blocked by the traces. If the arrangement density of the traces is increased in accordance with the reduction in the frame size, the fixation of the sealing member to the common board may become insufficient or timer that is required for the fixation may become longer. The sealing member is disposed not to overlap the light blocking portion that is included in the common board. By applying the light to the sealing member from the common board side to fix the sealing member to the array board, the light is less likely to be blocked by the light blocking portion. Therefore, the fixation of the sealing member to the array board can be properly accelerated. Even if the arrangement density of the traces is increased in accordance with the reduction in the frame size, the fixation of the sealing member to the array board can be properly accelerated regardless of the arrangement density of the traces. Furthermore, the sealing member has the light blocking property. Although the sealing member is disposed not to overlap the light blocking portion, leakage of light is less likely to occur in the non-display area. This configuration is preferable for reducing the frame size.

Preferable embodiments of the display panel according to the present invention may include the following configurations.

(1) The common board may include a planarization layer that is layered on a medium layer side relative to the light blocking portion. The planarization layer may be disposed in an area not to overlap the sealing member. According to the configuration, the sealing member is fixed to the common board with direct contact. Because the planarization layer is not disposed between the sealing member and the common board, the sealing member is more strongly fixed to the common board. Furthermore, only an interface between the sealing member and the common board is exposed to the outside. In comparison to a configuration in which the planarization layer is disposed between the sealing member and the common board, an area of the interface exposed to the outside is reduced. Therefore, external moisture is less likely to pass through the interface and enter into the medium layer.

(2) The sealing member may include an outer surface on an opposite side from the medium layer side. The outer surface maybe flush with at least an end surface of the common board. In comparison to a configuration in which the outer surface of the sealing member is located inner than the end surface of the common board, the frame size can be further reduced.

(3) The sealing member may be made of synthetic resin material with a light blocking compound contained in the synthetic resin material. According to the configuration, the light blocking compounds can be easily disposed in the synthetic resin material when mixing the light blocking compounds into the synthetic resin material. Therefore, the sealing member that delivers even light blocking performance can be easily provided. In comparison to a configuration in which the sealing member is made of metal material, the sealing member can be fixed to the common board at a lower temperature.

(4) The display panel may include sealing member control portions that are disposed to sandwich the sealing member from the medium layer side and an opposite side from the medium layer side. According to the configuration, the width of the sealing member can be controlled during the formation of the sealing member. Therefore, the width of frame of the display panel can be set with high accuracy. This configuration is further preferable for reducing the frame size.

(5) The sealing member control portions may extend parallel to the sealing member and include holes in the middle. According to the configuration, a material in an uncured state can be released through the holes of the sealing member control portions during the formation of the sealing member. Therefore, the sealing member has a constant height.

(6) The sealing member may contain spacer particles. This configuration is preferable for maintain the height of the sealing member constant.

(7) The sealing member maybe disposed to separate the pixels from one another together with the light blocking portion. In comparison to a configuration, in which the light blocking portion has a frame section along the sealing member and the pixels are separated from one another only by the light blocking portion, this configuration is further preferable for reducing the frame size.

### Advantageous Effect of the Invention

According to the present invention, the liquid crystal panel and the method of producing the liquid crystal panel preferable for reducing the frame size.

### BRIEF DESCRIPTION OF THE DRAWINGS

FIG. 1 is a schematic plan view illustrating connection among a liquid crystal panel that includes a drive according to a first embodiment of the present invention, a flexible circuit board, and a control circuit board.

FIG. 2 is a schematic cross-sectional view illustrating a cross-sectional configuration along a short direction of a liquid crystal display device.

FIG. 3 is a schematic cross-sectional view illustrating an overall cross-sectional configuration of the liquid crystal panel.

FIG. 4 is a schematic cross-sectional view illustrating a cross sectional configuration of a section of the liquid crystal panel in a display area.

FIG. 5 is a plan view schematically illustrating a wiring configuration of an array board included in the liquid crystal panel.

FIG. 6 is a plan view illustrating a wiring configuration of TFTs in a peripheral section of the liquid crystal panel and positional relation between a sealing member and the display area.

FIG. 7 is a cross-sectional view illustrating a cross-sectional configuration of the peripheral section of the liquid crystal panel.

FIG. 8 is a plan view of a CF base board that is produced through a CF base board producing process.

FIG. 9 is a plan view of an array base board that is produced through an array base board producing process.

FIG. 10 is a side view illustrating a schematic configuration of a sealing member forming device used in a sealing member forming process.

FIG. 11 is a side view illustrating a side view illustrating a sealing material discharged by a dispenser in a sealing material disposing process included in the sealing member forming process.

FIG. 12 is a side view illustrating rolling and compressing of the sealing material by a first roller in the sealing member forming process.

FIG. 13 is a side view illustrating output of laser beams by a laser beam output port in a sealing material curing process included in the sealing member forming process.

FIG. 14 is a side view illustrating rolling and compressing of the sealing material by a second roller in the sealing member forming process.

FIG. 15 is a plan view of an array base board on which a sealing member is formed through the sealing member forming process.

FIG. 16 is a plan view of a CF base board on which a base sealing material is disposed through a base sealing material disposing process.

FIG. 17 is a cross-sectional view illustrating the CF base board on which a liquid crystal material is dropped and the array base board before the array base board is bonded to the CF board in a board bonding process.

FIG. 18 is a cross-sectional view illustrating the base boards that are bonded together in the board bonding process.

FIG. 19 is a cross-sectional view illustrating application of laser beams onto the sealing member in the sealing member fixing process.

FIG. 20 is a plan view illustrating the base boards with a base sealing member formed through a base sealing material curing process.

FIG. 21 is a cross-sectional view illustrating a cross-sectional configuration of an outer edge section of a liquid crystal panel according to a second embodiment of the present invention.

FIG. 22 is a plan view illustrating a wiring configuration of TFTs and a positional relation between a sealing member and a display area in the outer edge section of the liquid crystal panel.

FIG. 23 is a side view illustrating a schematic configuration of a sealing member forming device used in a sealing member forming process according to a third embodiment of the present invention.

FIG. 24 is a cross-sectional view illustrating a cross-sectional configuration of an outer edge section of a liquid crystal panel according to a fourth embodiment of the present invention.

FIG. 25 is a plan view illustrating a sealing material disposed between sealing member control portions in a sealing member forming process.

FIG. 26 is a plan view illustrating rolling and compressing of the sealing material by a first roller in the sealing member forming process.

### MODE FOR CARRYING OUT THE INVENTION

### First Embodiment

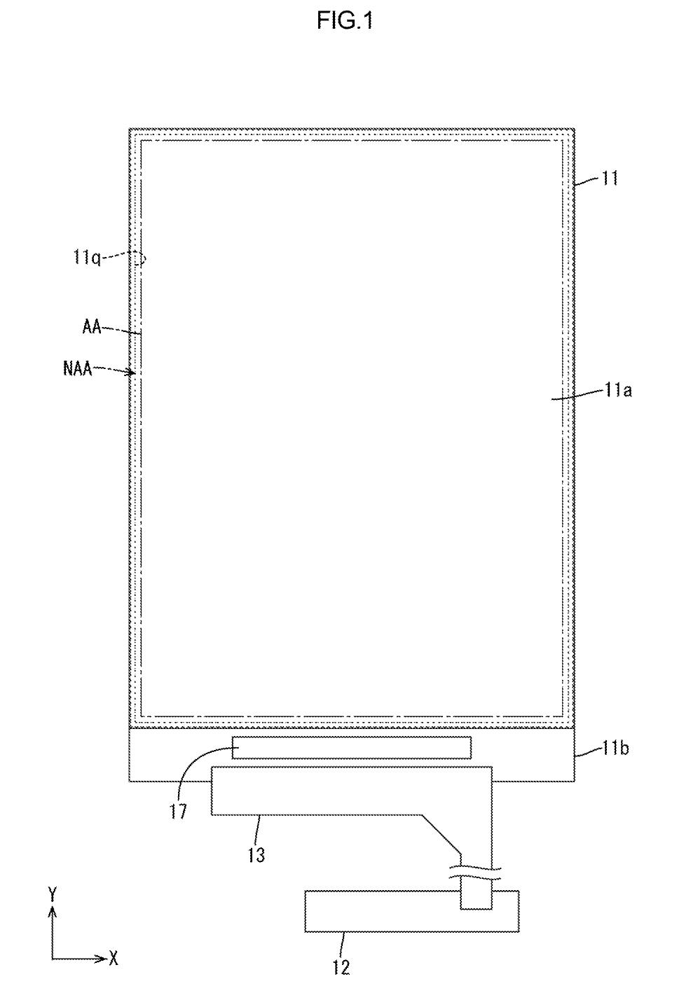

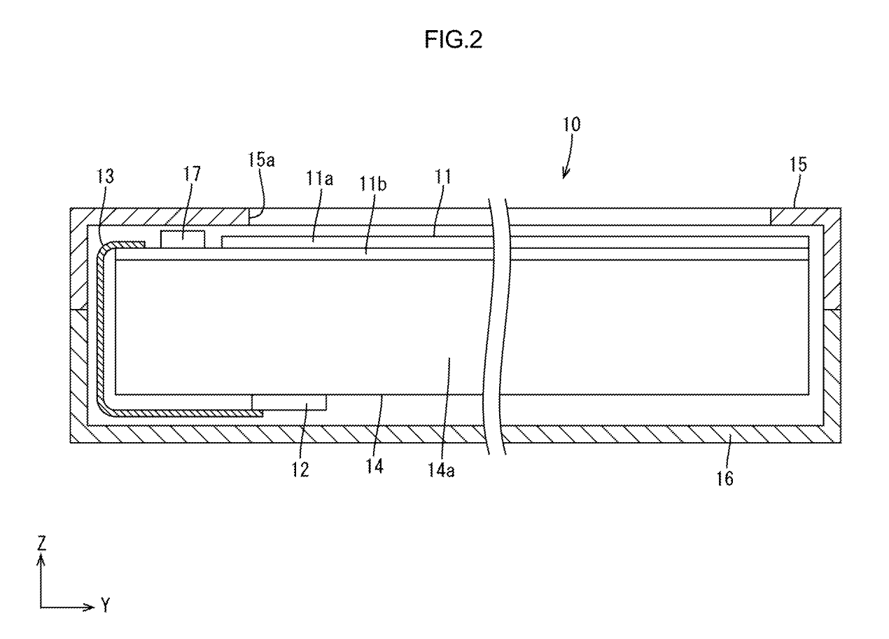

A first embodiment of the present invention will be described with reference to FIGS. 1 to 20. In this section, a liquid crystal display device 10 will be described. X-axes, Y-axes, and Z-axes may be present in drawings. The axes in each drawing correspond to the respective axes in other drawings to indicate the respective directions. A vertical direction of the liquid crystal display device 10 is defined based on FIGS. 2 to 4. Upper sides and lower sides in in FIGS. 2 to 4 correspond to a front side and a rear side of the liquid crystal display device 10, respectively.

As illustrated in FIGS. 1 and 2, the liquid crystal display device 10 includes a liquid crystal panel 11 (a display panel), a driver 17 (a panel driver), a control circuit board 12 (an external signal source), a flexible circuit board 13 (an external connecting component), and a backlight unit 14 (a lighting device). The liquid crystal panel 11 is configured to display images. The liquid crystal panel 11 includes a display area AA and a non-display area NAA. The display area AA is an inner area configured to display images. The non-display area NAA is an outer area to surround the display area AA. The driver 17 is configured to drive the liquid crystal panel 11. The control circuit board 12 is configured to supply various kinds of signals from outside to the driver 17. The flexible circuit board 13 electrically connects the liquid crystal panel 11 to the control circuit board 12 that is provided outside. The backlight unit 14 is an external light source for supplying light to the liquid crystal panel 11. The liquid crystal display device 10 includes a front exterior component 15 and a rear exterior component 16 provided as a pair to hold the liquid crystal panel 11 and the backlight unit 14 that are assemble together. The front exterior component 15 includes an opening 15a through which images displayed in the display area AA of the liquid crystal panel 11 can be viewed from the outside. The liquid crystal display device 10 according to this embodiment may be used in, but not limited to, an electronic device (not illustrated). Examples of the electronic device include mobile phones (including smart phones), laptop computers (including tablet-type laptop computers), wearable terminals (including smartwatches), mobile information terminals (including electronic books and PDAs), portable video game players, and digital photo frames. Therefore, a screen size of the liquid crystal panel 11 included in the liquid crystal display device 10 may be from several inches to a ten and several inches, which is usually classified as a small or a small-to-medium screen size.

The backlight unit 14 will be briefly described. As illustrated in FIG. 2, the backlight unit 14 includes a chassis 14a, alight source (e.g. cold cathode fluorescent tubes, LEDs, organic ELs), which are not illustrated, and an optical member, which is not illustrated. The chassis 14a has a box-like shape. The light sources are disposed inside the chassis 14a. The optical member is disposed to cover an opening of the chassis 14a. The optical member is configured to convert light emitted by the light sources into planar light.

Next, the liquid crystal panel 11 will be described. As illustrated in FIG. 1, the liquid crystal panel 11 has a vertically-long rectangular overall shape. At a position closer to a first end of the liquid crystal panel 11 with respect to a long direction of the liquid crystal panel 11 (the upper side in FIG. 1), the display area AA (an active area) is provided. The driver 17 and the flexible circuit board 13 are mounted at positions closer to a second end of the liquid crystal panel 11 with respect to the long direction of the liquid crystal panel 11 (the lower side in FIG. 1). In the liquid crystal panel 11, the area outside the display area AA is the non-display area NAA (a non-active area) in which images are not displayed. The non-display area NAA includes a frame-shaped region that surrounds the display area AA (a frame-shaped section of a CF board 11a, which will be described later) and a region that is provided at the second end with respect to the long direction (a section of an array board 11b which is exposed without overlapping the CF board 11a, which will be described later). The region provided at the second end with respect to the long direction includes a mounting region (an attachment region) in which the driver 17 and the flexible circuit board 13 are mounted. A width of three sections (non-mounting edge sections) other than the mounting area in which the driver 17 and the flexible circuit board 13 are located, more specifically, a linear distance between an outer edge of an glass substrate GS and an outer edge of the display area AA (a frame width) is 0.5 mm or less. Namely, the liquid crystal panel 11 has a significantly narrow frame configuration in which the frame size is significantly small. The short direction of the liquid crystal panel 11 corresponds with the X-axis direction in the drawings and the long direction of the liquid crystal panel 11 corresponds with the Y-axis direction in the drawings. In FIGS. 1, 5, and 6, a chain line slightly smaller than the CF board 11a in a frame shape indicates an outline of the display area AA and an area outside the chain line is the non-display area NAA.

Next, the components connected to the liquid crystal panel 11 will be described. As illustrated in FIGS. 1 and 2, the control circuit board 12 is mounted to a back surface of the chassis 14a of the backlight unit 14 (an outer surface on an opposite side from the liquid crystal panel 11 side) with screws. The control circuit board 12 includes a substrate made of paper phenol or glass epoxy resin. Electronic components for supplying various signals to the driver 17 are mounted on the substrate and traces (conductive lines), which are not illustrated, are formed and routed. One of ends (a first end) of the flexible circuit board 13 is electrically and mechanically connected to the control circuit board 12 via an anisotropic conductive film (ACF), which is not illustrated.

As illustrated in FIG. 2, the flexible circuit board 13 includes a base member made of synthetic resin material (e.g., polyimide-based resin) having an insulating property and flexibility. A number of traces, which are not illustrated, are formed on the base member. As described earlier, the first end of the flexible circuit board 13 with respect to the long direction is connected to the control circuit board 12 disposed on the back surface of the chassis 14a. The other one of the ends (a second end) of the flexible circuit board 13 connected to the array board 11b of the liquid crystal panel 11. The flexible circuit board 13 is folded to turn back and to have a U-shaped cross section in the liquid crystal display device 10. At the ends of the flexible circuit board 13 with respect to the long direction, sections of the traces are exposed and configured as terminals (not illustrated). The terminals are electrically connected to the control circuit board 12 and the liquid crystal panel 11. According to the configuration, the signals supplied by the control circuit board 12 are transmitted to the liquid crystal panel 11.

As illustrated in FIG. 1, the driver 17 is an LSI chip that includes a drive circuit therein. The driver 17 is configured to operate based on the signals supplied by the control circuit board 12, which is a signal source. The driver 17 is configured to process the signals supplied by the control circuit board 12, which is a signal source, to generate output signals, and output the output signals to the display area AA of the liquid crystal panel 11. The driver 17 has a horizontally-long rectangular shape (an elongated shape along a short edge of the liquid crystal panel 11) in a plan view. The driver 17 is directly mounted in the non-display area NAA of the liquid crystal panel 11 (on the array board 11b, which will be described later). Namely, the driver 17 is mounted with the chip-on-glass (COG) technology. The long direction of the driver 17 corresponds with the X-axis direction (the short direction of the liquid crystal panel 11) and the short direction of the driver 17 corresponds with the Y-axis direction (the long direction of the liquid crystal panel 11).

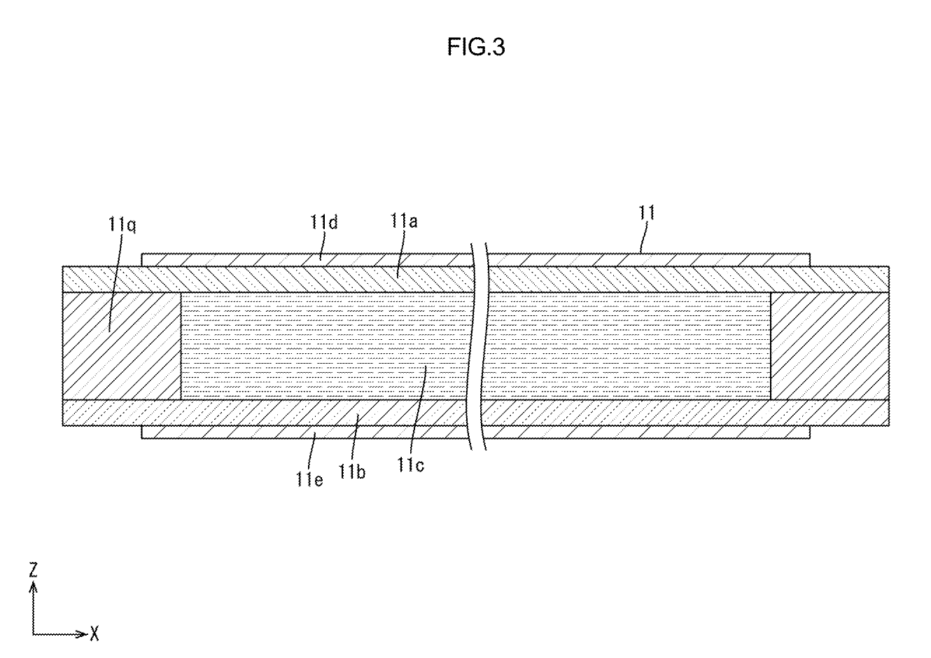

The liquid crystal panel 11 will be described. As illustrated in FIG. 3, the liquid crystal panel 11 includes at least a pair of the boards 11a and 11b, a liquid crystal layer 11c (a medium layer), and a sealing member 11q. The liquid crystal layer 11c is sandwiched between the boards 11a and 11b. The liquid crystal layer 11c includes liquid crystal molecules that are substances having optical characteristics that vary according to application of an electric field. The sealing member 11q is disposed between the boards 11a and 11b to surround the liquid crystal layer 11c. The sealing member 11q seals the liquid crystal layer 11c while maintaining a cell gap in a size that corresponds with a thickness of the liquid crystal layer 11c. Although the cell gap in the liquid crystal panel 11 in this embodiment is set to about 3 to 4 μm, the size of the cell gap can be altered where appropriate. One of the boards 11a and 11b on the front side is the CF board a (a second board, a common board). The other one of the boards 11a and 11b on the rear side (the back side) is the array board 11b (a first board, an active matrix board). The CF board 11a and the array board 11b include glass substrates GS that are made of glass and various films that are formed in layers on inner surfaces of the glass substrates GS. The sealing member 11q is disposed in the non-display area NAA of the liquid crystal panel 11. The sealing member 11q has a vertically-long frame shape along the non-display area NAA in the plan view (the view in a normal direction to a plate surface of the array board 11b) (FIG. 2). The sealing member 11q has a width of about 400 μm in the significantly narrow frame configuration in which the frame width of the liquid crystal panel 11 is 0.5 min or less. Sections of the sealing member 11q disposed in three edge areas (non-mounting edge areas) other than the mounting area in which the driver 17 and the flexible circuit board 13 are located at the outermost in the non-display area NAA (FIG. 2). Polarizing plates 11d and 11e are attached to outer surfaces of the boards 11a and 11b, respectively.

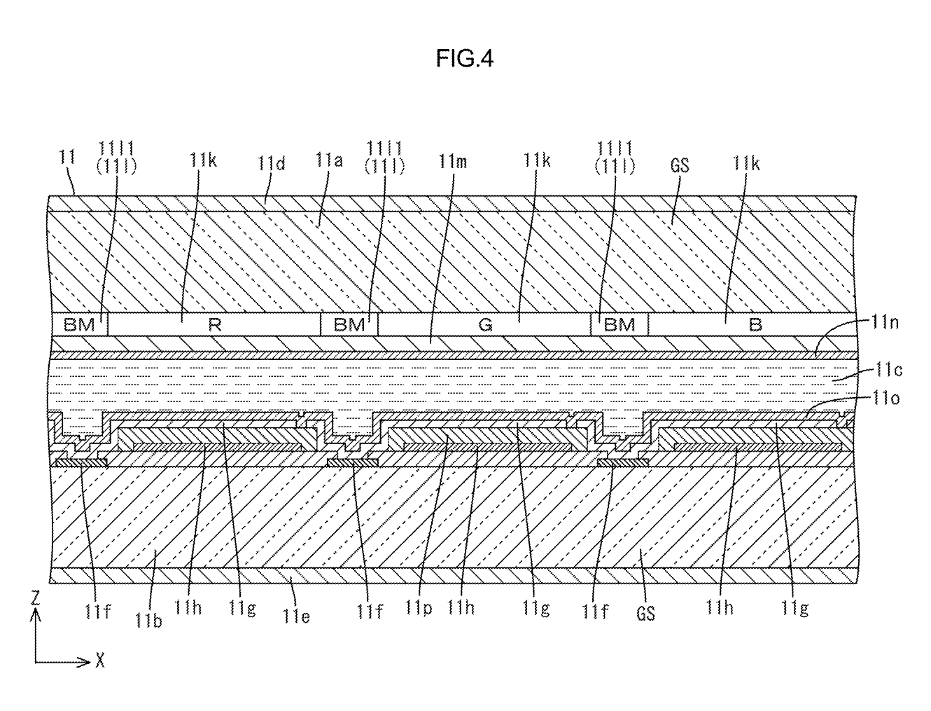

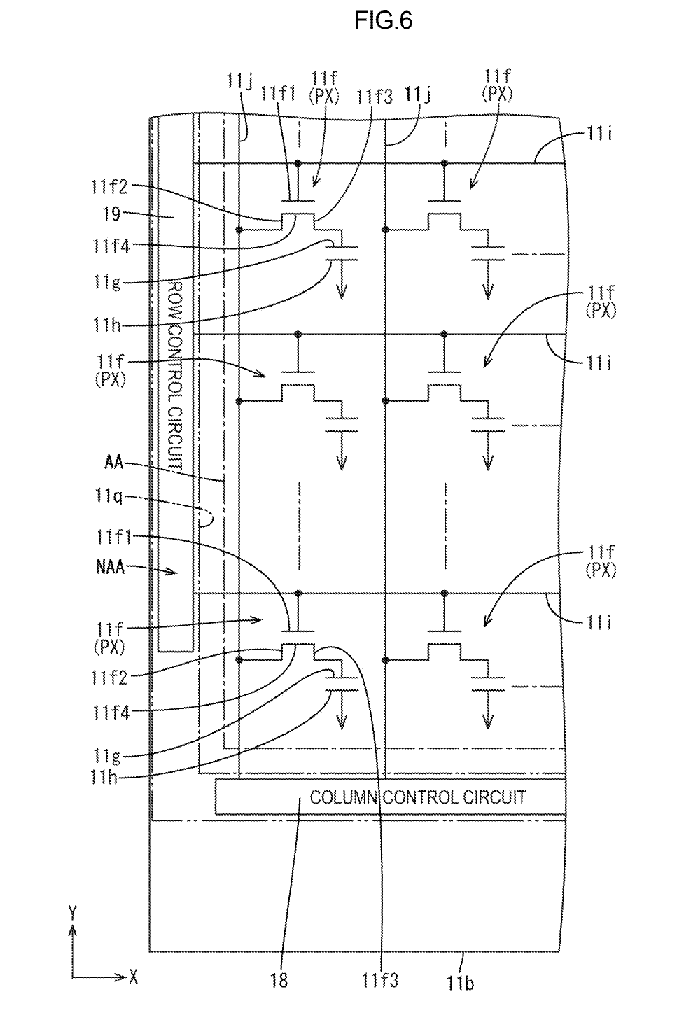

On an inner surface of the array board 11b (on a liquid crystal layer 11c side, an opposed surface that is opposed to the CF board 11a), as illustrated in FIGS. 4 and 6, thin film transistors (TFTs, display components) 11f which are switching components and pixel electrodes 11g are arranged in rows and columns (in a matrix). Gate lines 11i (scan lines) and source lines 11j (data lines, signal lines) are routed in a grid to surround the TFTs 11f and the pixel electrodes 11g. The gate lines 11i and the source lines 11j are connected to gate electrodes 11f1 and source electrodes 11f2 of the TFTs 11f, respectively. The pixel electrodes 11g are connected to drain electrodes 11f3 of the TFTs 11f. The TFTs 11f are driven based on signals supplied to the gate lines 11i and the source lines 11j. The TFTs 11f are driven based on various signals supplied to the gate lines 11i and the source lines 11j. Application of voltages to the pixel electrodes 11g is controlled in accordance with the driving of the TFTs 11f. The TFTs 11f include channels 11f4 that connect the drain electrodes 11f3 to the source electrodes 11f2. An oxide semiconductor film is used to form the channels 11f4. The oxide semiconductor film of the channels 11f4 has electron mobility 20 to 50 times higher in comparison to an amorphous silicon thin material. Therefore, the TFTs 11f can be easily reduced in size to obtain an optimal amount of transmitted light through the pixel electrodes 11g (an aperture rate of display pixels). This configuration is preferable for increasing the definition and reducing the power consumption. The pixel electrodes 11g are disposed in quadrilateral areas defined by the gate lines 11i and the source lines 11j. The pixel electrodes 11g are formed from a transparent electrode film (an upper layer-side transparent electrode film) made of indium tin oxide (ITO) or zinc oxide (ZnO). The pixel electrodes 11g are layered on an insulating film lip on an upper layer side relative to the insulating film 11p. Common electrodes 11h are layered under the insulating film 11p on a lower layer side relative to the insulating film 11p. The common electrodes 11h are formed from the transparent electrode film (the lower layer-side transparent electrode film) similarly to the pixel electrodes 11g. The common electrodes 11h are formed as a solid pattern. The array board 11b includes the pixel electrodes 11g and the common electrodes 11h. When a potential difference is created between the electrodes 11g and 11h, a fringe electric field (an oblique electric field) including a component along the plate surface of the array board 11b and a component in the normal direction to the plate surface of the array board 11b. The liquid crystal panel 11 operates in fringe field switching (FFS) mode that is an improved version of in-plane switching (IPS) mode. In this embodiment, an extending direction in which the gate lines 11i extend and an extending direction in which the source lines 11j extend correspond with the X-axis direction and Y-axis direction in the drawings, respectively.

As illustrated in FIG. 4, on the inner surface of the CF board 11a in the display area AA, color filters 11k are arranged at positions opposed to the pixel electrodes 11g on the array board 11b. The color filters 11k include red (R), green (G), and blue (B) color portions in three colors. The R color portions, the G color portions, and the B color portion are repeatedly arranged to form a matrix. The color portions (the pixels PX) of the color filters ilk arranged in the matrix are separated from one another with a light blocking portion 11l (a black matrix). With the light blocking portion 11l, color mixture of different colors of light rays that pass through the color portions is less likely to occur. The light blocking portion 11l is formed in a grid in the plan view. The light blocking portion 11l includes dividing sections 1111 and a frame section 1112. The dividing sections 1111 a grid shape in the plan view and separate the color port ions from one another. The frame portion 1112 has a frame shape (a picture frame shape) in the plan view and surrounds the dividing sections 1111 from the peripheral sides. The dividing sections 1111 are disposed to overlap the gate lines 11i and the source lines 11j in the plan view. The frame section 1112 extends along the sealing member 11q and has a vertically-long rectangular shape in the plan view. A planarization layer 11m (an overcoat layer) is layered on the color filters 11k and the light blocking portion 11l. In the liquid crystal panel 11, each color potion of the color filter 11k and the pixel electrode 11g that is opposed to the color potion form a single pixel PX. The pixels PX include red pixels, green pixels, and blue pixels. The red pixels include the R color portions of the color filters 11k. The green pixels include the G color portions of the color filters 11k. The blue pixels include the B color portions of the color filters 11k. The pixels PX in three colors are repeatedly arranged along the row direction (the X-axis direction) on the plate surface of the liquid crystal panel 11 to form pixel lines. A number of the pixel lines are arranged along the column direction (the Y-axis direction). Namely, a number of the pixels PX are arranged in a matrix in the display area AA of the liquid crystal panel 11.

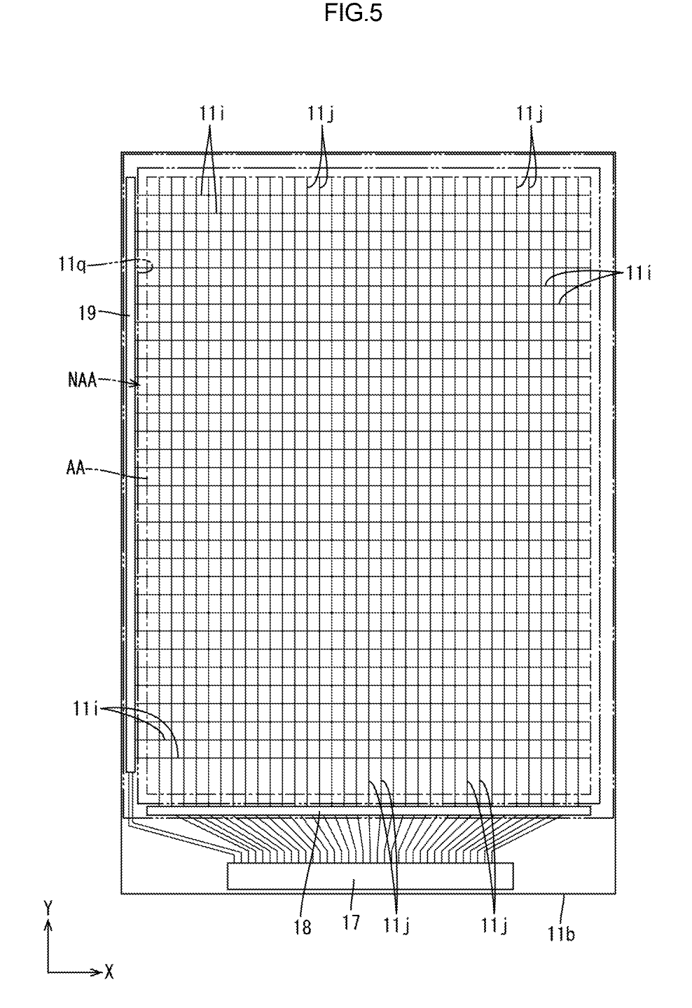

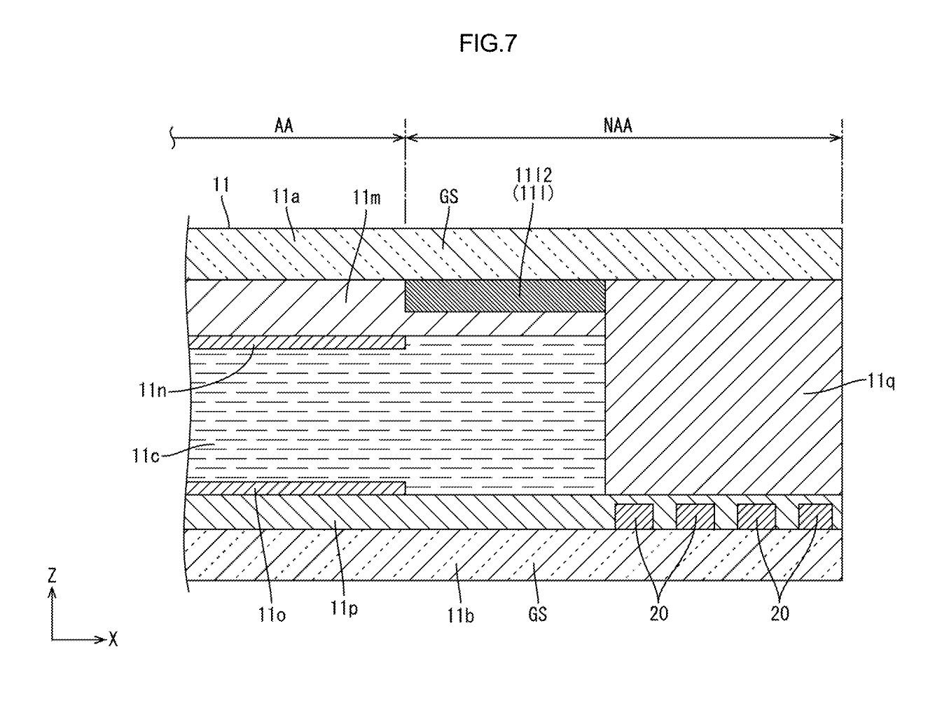

Next, the configuration of the array board 11b in the non-display area NAA will be described in detail. As illustrated in FIG. 5, in the non-display area NAA, a column control circuit 18 is disposed in a section of the array board 11b adjacent to a short edge of the display area AA and a row control circuit 19 is disposed in a section of the array board 11b adjacent to a long edge of the display area AA. The column control circuit 18 and the row control circuit 19 are configured to perform control for supplying the signals that are output by the driver 17 to the TFTs 11f. The column control circuit 18 and the row control circuit 19 are monolithically fabricated on the array board 11b with the oxide semiconductor film, which are the same semiconductor film of the channels 11f4 of the TFTs 11f, as a base. The column control circuit 18 and the row control circuit 19 include control circuits for controlling the supply of the output signals to the TFTs 11f. The control circuits in the column control circuit 18 and the row control circuit 19 include at least control TFTs and traces 20 that are connected to the control TFTs. As illustrated in FIGS. 5 and 6, the column control circuit 18 and the row control circuit 19 are disposed in sections of the CF board 11a closer to the outer edges of the non-display area. Namely, the column control circuit 18 and the row control circuit 19 are disposed to overlap the sealing member 11q. As illustrated in FIG. 7, the sealing member 11q overlaps the traces 20 that are including in the control circuits of the column control circuit 18 and the row control circuit 19. In FIGS. 5 and 6, the sealing member 11q is indicated by two-dashed chain lines. The outer edges of the sealing member 11q substantially correspond with the outer edges of the CF board 11a. The inner edges of the sealing member 11q are disposed on inner side (closer to the display area AA) than the inner edges of the control circuits 18 and 19. In a production process of the array board 11b, the control circuits of the column control circuit 18 and the row control circuit 19 are patterned on the array board 11b simultaneously with the patterning of the TFTs 11f by a known photolithography method.

As illustrated in FIG. 5, the column control circuit 18 is disposed adjacent to the short edge of the display area AA on the lower side in FIG. 5, that is, between the display area AA and the driver 17 with respect to the Y-axis direction. The column control circuit 18 overlaps one of the short sections of the sealing member 11q which extends along the X-axis direction in the plan view. The column control circuit 18 is disposed in a horizontally-long rectangular area that extends in the X-axis direction. The column control circuit 18 is connected to the source lines 11j disposed in the display area AA. The column control circuit 18 includes a switching circuit (an RGB switching circuit) for distributing image signals that are included in the output signals from the driver 17 to the source lines 11j. Specifically, a large number of the source lines 11j are disposed on the array board 11b in the display area AA along the X-axis direction. The source lines 11j are connected to the respective TFTs 11f that are connected to the respective pixel electrodes 11g that form the R (red) pixels PX, the G (green) pixels PX, and the B (blue) pixels PX. The column control circuit 18 is configured to distribute the image signals from the driver 17 to the source lines 11j of R, G, and B through the switching circuit. The column control circuit 18 may include an auxiliary circuit such as a level shifter circuit and an ESD protection circuit.

As illustrated in FIG. 5, the row control circuit 19 is disposed adjacent to the long edge of the display area AA on the left side in FIG. 5. The row control circuit 19 is disposed in a vertically-long rectangular area that extends along the Y-axis direction. The row control circuit 19 overlaps one of the long sections of the sealing member 11q which extends along the Y-axis direction in the plan view. The row control circuit 19 is connected to the gate lines 11i that are disposed in the display area AA. The row control circuit 19 includes a scanning circuit that is configured to supply scan singles included in the output signals from the driver 17 to the gate lines 11i at predefined timing to scan the gate lines in sequence. Specifically, a large number of the gate lines 11i are arranged on the array board 11b in the display area AA along the Y-axis direction. The row control circuit 19 is configured to scan the gate lines 11i by supplying the control signals (scan signals) from the driver 17 to the gate lines from the gate line 11i at the uppermost to the gate line 11i at the lowermost in FIG. 5 in the display area AA through the scanning circuit. The row control circuit 19 includes a buffer circuit for amplifying the scan signals. The row control circuit 19 may include an auxiliary circuit such as a level shifter circuit and an ESD protection circuit. The column control circuit 18 and the row control circuit 19 are connected to the driver 17 via connecting traces, which are not illustrated, formed on the array board 11b.

In the liquid crystal panel 11 in this embodiment, the sealing member 11q is formed on a CF board 11a side by curing the material through application of laser beams and fixed to the array board 11b through application of the laser beams during bonding of the boards 11a and 11b in the production process of the liquid crystal panel 11. The sealing member 11q is made of the material having the light blocking property. As illustrated in FIG. 7, the sealing member 11q is disposed to overlap the traces 20 of the control circuits 18 and 19 in the non-display area NAA but not overlap the light blocking portion 11l. In this embodiment, the liquid crystal panel 11 has the narrow frame design. Therefore, the sealing member 11q is disposed to overlap traces 20 that included in the array board 11b in the non-display area NAA. When the fixation of the sealing member 11q to the CF board 11a is accelerated by the laser beams that are applied from the array board 11b side, the laser beams may be blocked by the traces 20. Especially, if arrangement density of the traces 20 is increased and intervals between the traces 20 is reduced in accordance with the reduction in the frame size, the fixation of the sealing member 11q to the CF board 11a may become insufficient or a longer period of time may be required for the fixation of the sealing member 11q. Because the sealing member 11q is disposed not to overlap the light blocking portion 11l of the CF board 11a, the laser beams are less likely to be blocked by the light blocking portion 11l by applying the laser beams from the CF board 11a side for the fixation the sealing member 11q to the array board 11b. According to the configuration, the fixation of the sealing member 11q to the array board 11b can be properly accelerated. Even if the arrangement density of the traces 20 is increased in accordance with a reduction in the frame size, the fixation of the sealing member 11q to the array board 11b can be properly accelerated regardless of the arrangement density of the traces 20. Because the sealing member 11q has the light blocking property, even if the sealing member 11q is disposed not to overlap the light blocking portion 11l, a leakage of light is less likely to occur in the non-display area NAA.

Specifically, a sealing material S of the sealing member 11q includes synthetic resin material (e.g., nylon powder made of nylon (polyamide)) and black light blocking compounds (e.g., carbon powder (carbon black)) dispersed in the synthetic resin material. The sealing member 11q is formed by sintering and curing the sealing material S with the laser beams. More specifically, to form the sealing member 11q, the sealing material S that is in the powdered form is disposed on the CF board 11a and the laser beams are applied to the sealing material S. A section of the sealing material S to which the laser beams are applied is selectively sintered and cured. Namely, by adjusting an area of the sealing material S to which the laser beams are applied, a forming area (e.g., a width) to form the sealing member can be set with high accuracy. The light blocking compounds are evenly disposed in the synthetic resin material of the sealing member 11q prepared by curing the sealing material S and fixed. According to the configuration, the sealing member 11q can deliver light blocking performance at the same level as the light blocking portion 11l and even light blocking performance. As illustrated in FIG. 7, the sealing member 11q is disposed such that an inner peripheral surface of the sealing member 11q contacts the outer peripheral surface of a frame section 1112 of the light blocking portion 11l. Therefore, the sealing member 11q can block a leakage of light from the non-display area together with the frame section 1112. The outer peripheral surface of the sealing member 11q on the opposite side from the liquid crystal layer 11c side (the light blocking portion 11l side) is flush with an outer end surface of the CF board 11a. This configuration is preferable for further reducing the frame size. Furthermore, the sealing material S of the sealing member 11q contains spacer particles. The spacer particles contained in the sealing material S may be silica beads. A diameter of each particle is about equal to the cell gap of the liquid crystal panel 11 (the thickness of the liquid crystal layer 11). With the spacer particles, the height of the sealing member 11q can be maintained constant with a value about equal to the cell gap for the entire periphery. Other than the spacer particles, inorganic filler, auxiliary agent, and additive agent may be added to the sealing material S where appropriate.

As illustrated in FIG. 7, the sealing member 11q is disposed not to overlap the planarization layer 11m formed on the CF board 11a. The planarization layer 11m is layered on the color filters 11k and the light blocking portion 11l with in the plane of the CF board 11a on the liquid crystal layer 11c side. Within the plane of the CF board 11a, the planarization layer 11m is solid. However, an outer peripheral section of the planarization layer 11m which may overlap the sealing member 11q is removed. Namely, the planarization layer 11m is selectively formed in the section of the inner peripheral surface of the CF board 11a which does not overlap the sealing member 11q. An outer peripheral surface of the planarization layer 11m is disposed to contact the inner peripheral surface of the sealing member 11q and flush with the outer peripheral surface of the frame section 1112 of the light blocking portion 11l. According to the configuration, the sealing member 11q is fixed to the glass substrate GS of the CF board 11a with direct contact. The planarization layer 11m and the light blocking portion 11l do not exist between the sealing member 11q and the CF board 11a. Therefore, the sealing member 11q is more strongly bonded to the CF board 11a. Because only an interface between the sealing member 11q and the CF board 11a is exposed to the outside, in comparison to a configuration in which the planarization layer 11m is disposed between the sealing member 11q and the CF board 11a, a size of the interface that is exposed to the outside can be reduced and thus moisture that exists the outside is less likely to enter into the liquid crystal layer 11c via the interface.

The liquid crystal panel 11 in this embodiment has the configuration described above. Next, the method of producing the liquid crystal panel 11 will be described. The method of producing the liquid crystal panel 11 in this embodiment includes a CF base board producing process (a first base board producing process), an array base board producing process (a second base board producing process), a sealing member forming process, a base sealing material disposing process, a board bonding process, a sealing member fixing process, a base sealing material curing process, and a cutting process. The CF base board producing process includes producing a CF base board 11aM (a first base board) which includes CF boards 11a within a plate surface thereof. The array base board producing process includes producing an array base board 11bM (a second base board) which includes array boards 11b within a plate surface thereof. The sealing member forming process includes forming the sealing member 11q by curing the sealing material S on the CF board 11a without any uncured sections. The base sealing material disposing process includes disposing a base sealing material MS that includes uncured sections on any one of the CF base board 11aM and the array base board 11bM to surround either the CF boards 11a or the array boards 11b. The board bonding process includes bonding the CF board 11a and the array board 11b with the liquid crystal layer 11c between the CF board 11a and the array board 11b. The sealing member fixing process includes fixing the sealing member 11q to the array board 11b. The base sealing material curing process includes curing the base sealing material MS without any uncured sections to form a base sealing member 21. The cutting process includes cutting the cutting the base boards 11aM and 11bM to obtain the liquid crystal panels 11. In the sealing member forming process, the expression “the sealing material S is cured without any uncured section” does not mean that the extent of curing is 100%. The extent of curing lower than 100% may be included.

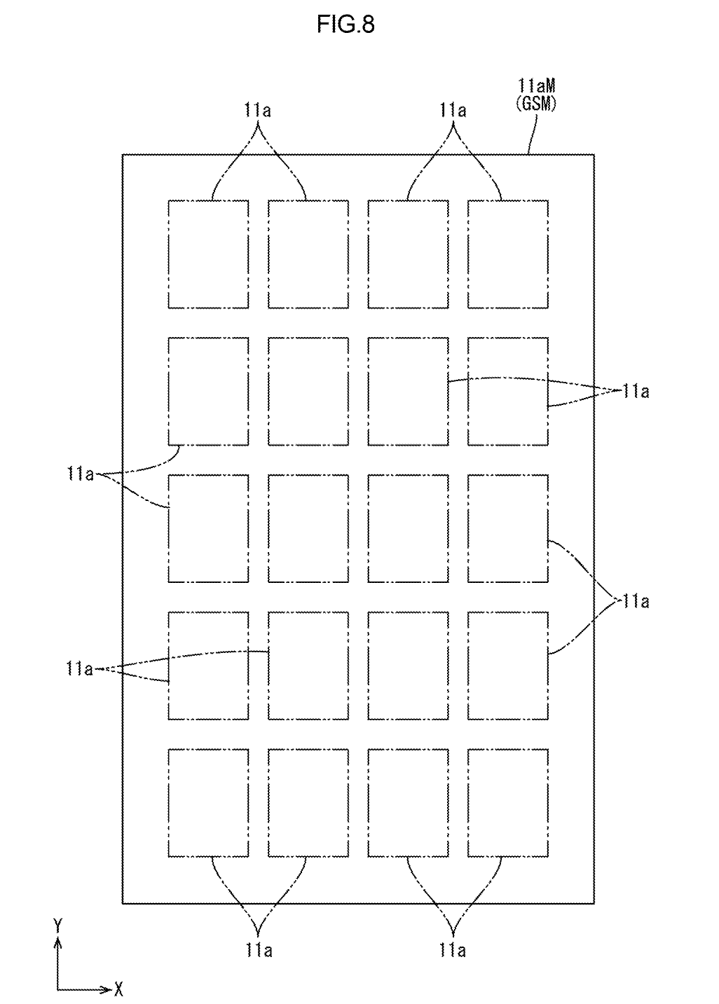

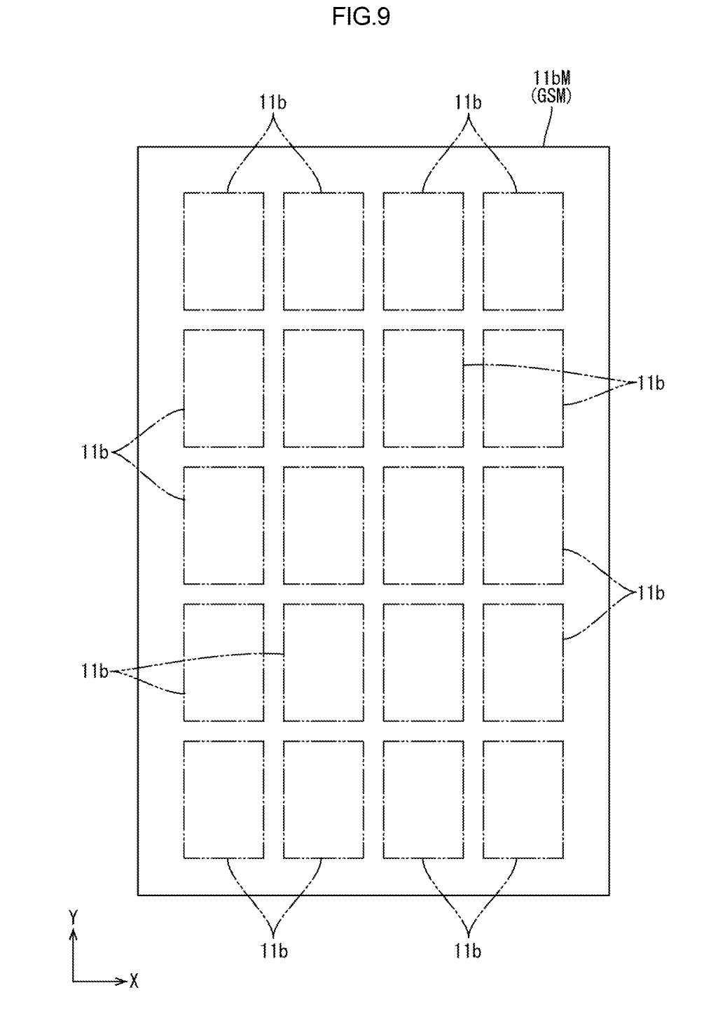

As illustrated in FIG. 8, in the CF base board producing process, various films are formed on a plate surface of a large-sized glass base substrate GSM by a known photolithography method and the films are processed through patterning to form components of the CF boards 11a in layers. Through the process, the CF base board 11aM is produced. As illustrated in FIG. 9, in the array base board producing process, various films are formed on a plate surface of a large-sized glass base substrate GSM by a known photolithography method and the films are processed through patterning to form components of the array boards 11b in layers. Through the process, the array base board 11bM is produced. In FIGS. 8 and 9, the CF boards 11a and the array boards 11b within the respective glass base substrates GSM are indicated by two-dashed chain lines. The CF boards 11a are arranged in a matrix within the plate surface of the glass base substrate GSM and the array boards 11b are arranged in a matrix within the plate surface of the glass base substrate GSM. Specifically, four along the X-axis direction by five along the Y-axis direction of those are arranged. The number of the CF boards 11a or the array boards 11b arranged within the plate surface of each glass base substrate GSM can be altered from the number described above where appropriate. Short dimensions and long dimensions of the CF base board 11aM and the array base board 11bM may be about in a range from 660 to 1500 mm and a range from 880 to 1800 mm, respectively. The dimensions may be altered where appropriate.

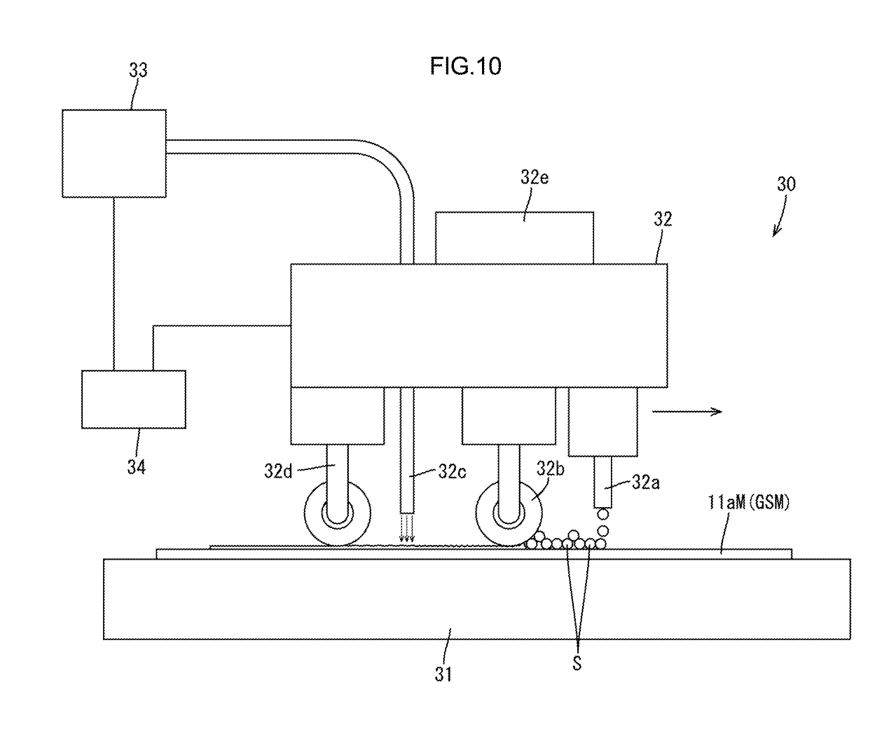

In the sealing member forming process, the sealing member 11q is formed on each CF board 11a of the CF base board 11aM using a sealing member forming device 30 that is a powder sintering type forming device described below. As illustrated in FIG. 10, the sealing member forming device 30 includes at least a stage 31, a head 32, a light source 33, and a controller 34. The CF base board 11aM is placed on the stage 31. The head 32 is disposed opposite the CF base board 11aM on the stage 31. The light source 33 is connected to the head 32 and configured to emit the laser beam toward the CF base board 11aM. The controller 34 is connected to the head 32 and the light source 33 and configured to control the head 32 and the light source 33. The stage 31 can move the CF base board 11aM along the X-axis direction, the Y-axis direction, and the θ direction (the rotational direction) which are parallel to the plate surface of the CF base board 11aM. The head 32 includes at least a dispenser 32a, a first roller 32b, a laser beam output port 32c, a second roller 32d, and a driver 32e. The dispenser 32a is configured to supply the sealing material S onto the CF base board 11aM. The first roller 32b is disposed adjacent to the dispenser 32a to roll and compress the sealing material S. The laser beam output port 32c is configured to apply the laser beam to the CF base board 11aM. The second roller 32d is disposed adjacent to the laser beam output port 32c to roll and compress the sealing material S to which the laser beam has been applied. The driver 32e is configured to drive the dispenser 32a, the first roller 32b, the laser beam output port 32c, and the second roller 32d. The light source 33 may include a carbon dioxide laser unit that is configured to emit an oscillating carbon dioxide laser beam (CO₂ laser beam). The light source 33 is connected to the head 32 via optical fibers to supply the carbon dioxide laser beam to the laser beam output port 32c that is included in the head 32. The controller 34 is configured to control the oscillation of the carbon dioxide laser beam by the light source 33. The controller 34 is configured to control the components 32a to 32e that are included in the head 32.

The configuration of the head 32 will be described in detail. The dispenser 32a is configured to discharge the sealing material S in the powdered form to form the sealing member. The dispenser 32a is configured to discharge the sealing material S in the powdered form in line in an area of the CF base board 11aM with a width smaller than the width of the sealing member 11q. The amount of the sealing material S discharged by the dispenser 32a is controlled by the driver 32e. The nylon powder that is the synthetic resin material to form the sealing material S and discharged by the dispenser 32a has a mean particle diameter of about 50 μm. A mean particle diameter of the spacer particles that are contained in the sealing material S is about 3 to 4 μm. By adding the organic filler, auxiliary agent, and additive agent to the sealing material S, flowability of the sealing material S during the rolling and compressing them by the first roller 32b can be improved. The first roller 32b can be move down to be set closer to the CF baseboard 11aM and up to be set away from the CF base board 11aM by the driver 32e. Specifically, when the sealing material S is not discharged by the dispenser 32a, the first roller 32b is set at a position away from the CF base board 11aM. During the discharge of the sealing material S by the dispenser 32a, the first roller 32b is set at a position closer to the CF base board 11aM. The first roller 32b is configured to grind the nylon powder to form the sealing material S between the first roller 32b and the CF baes board 11aM to reduce the particle diameters about equal to the cell gap or less and to spread them in the width direction of the sealing member 11q.

The laser beam output port 32c is disposed on an opposite side from the dispenser 32a relative to the first roller 32b with a distance larger than a distance between the first roller 32b and the dispenser 32a. The laser beam output port 32c is configured to apply the laser beam that is supplied by the light source to the sealing material S on the CF base board 11aM. It is preferable that the carbon dioxide laser beam output from the laser beam output port 32c has a wavelength of about 9.2 to 10.8 μm and an intensity of about 25 kW. When the laser beam is applied to the sealing material S, the nylon powder that is a main component of the sealing material S is sintered. The second roller 32d is configured to move down to be set closer to the CF base board 11aM and up to be set away from the CF base board 11aM by the driver 32e. Specifically, when the laser beam is not output from the laser beam output port 32c, the second roller 32d is set at a position away from the CF base board 11aM. During the output of the laser beam from the laser beam output port 32c, the second roller 32d is set at a position closer to the CF base board 11aM. The second roller 32d may include a heater, which is not illustrated. The second roller 32d may be heated to about 160° C. According to the configuration, the sealing material S that is in a condition immediately after the laser beam is applied can be softened during the rolling and compressing of the sealing material S.

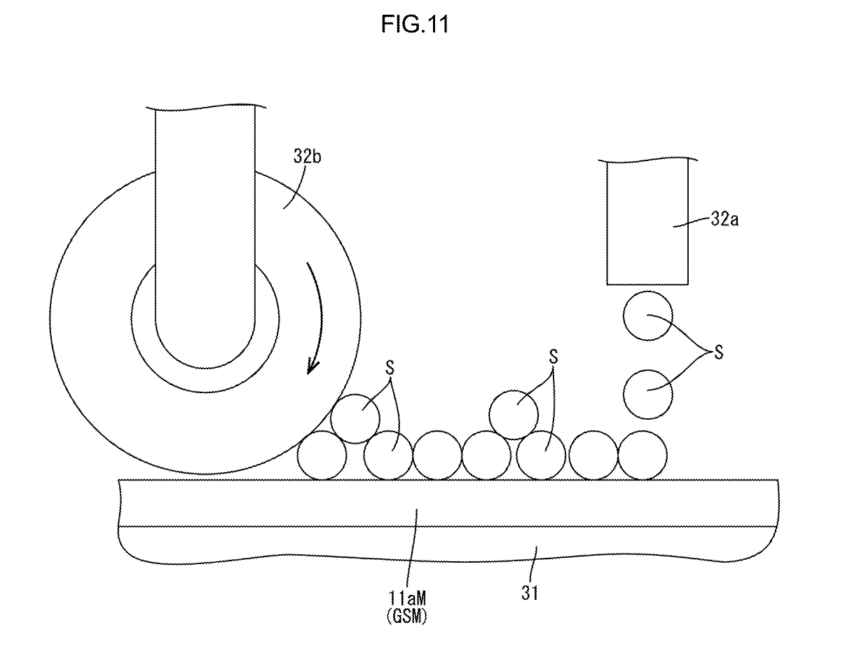

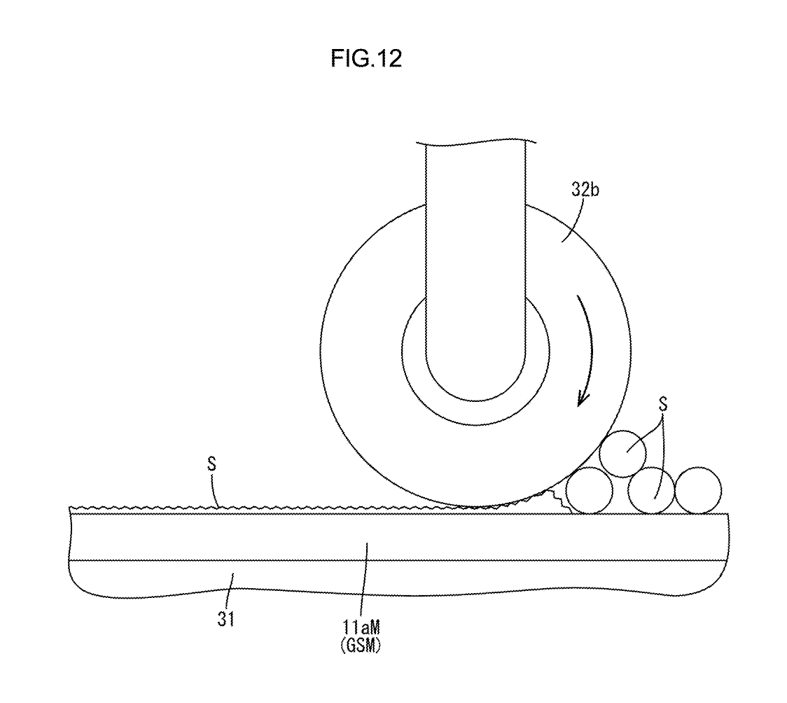

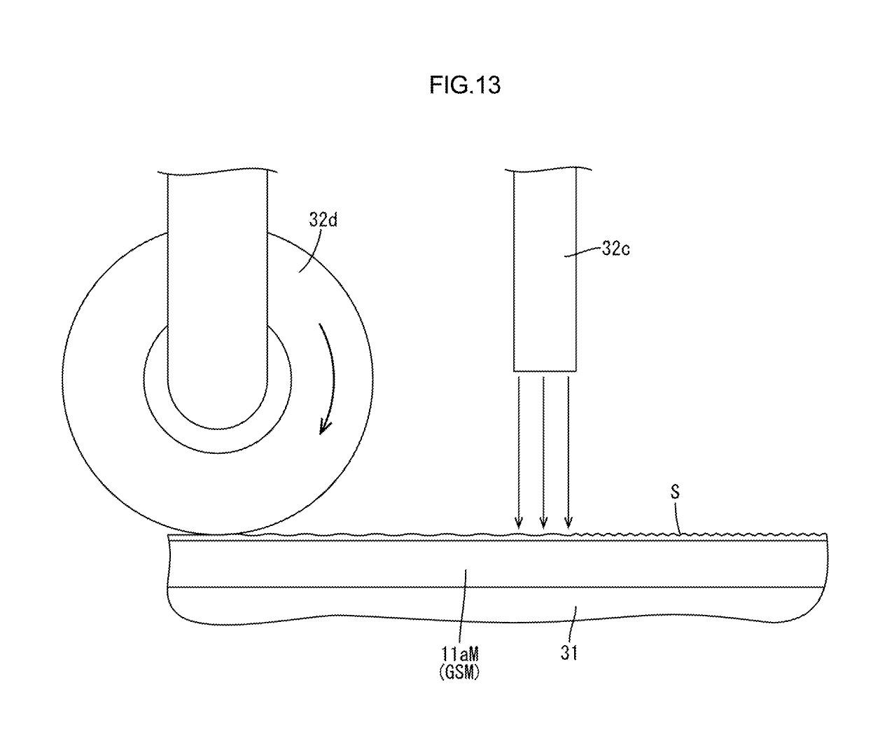

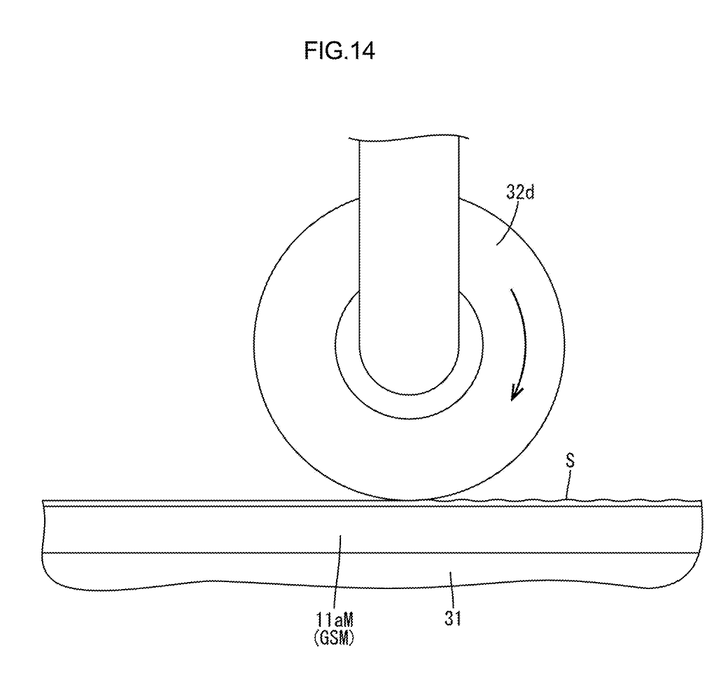

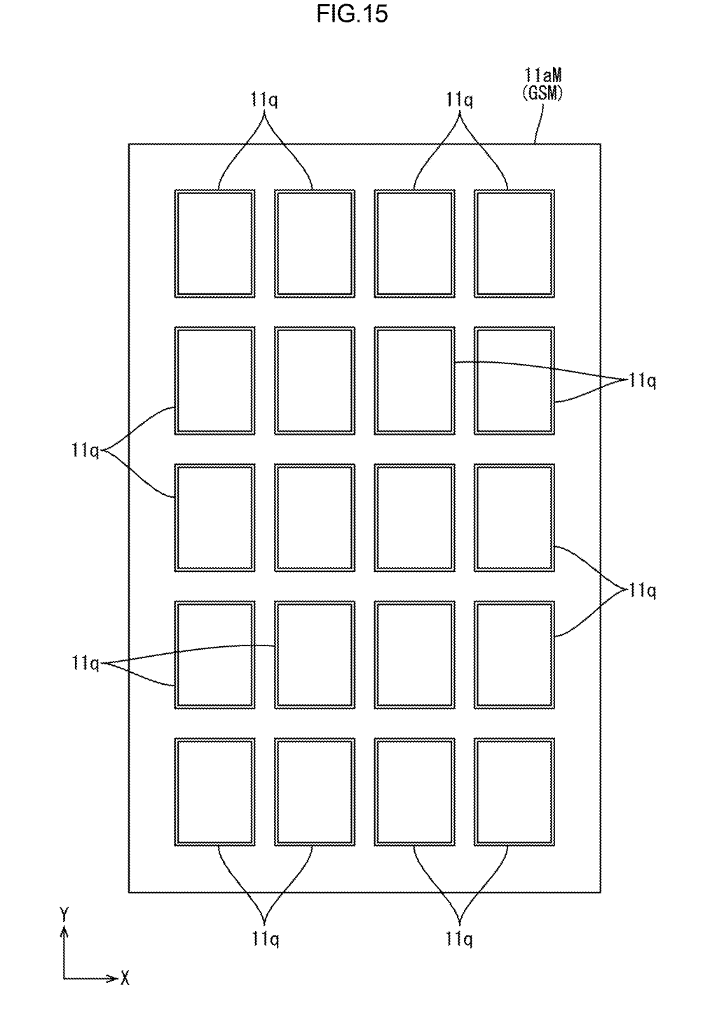

The sealing member forming process will be described in detail. The sealing member forming process includes the sealing material disposing process and the sealing material curing process. The sealing material disposing process includes disposing the sealing material S that is in the powdered form on the CF board 11a. The sealing material curing process includes applying the laser beam to the sealing material S and selectively curing the section of the sealing material S to which the laser beam is applied without any uncured areas. In the sealing member forming process, the CF base board 11aM is placed on the stage 31 of the sealing member forming device 30. In the sealing material disposing process that is included in the sealing member forming process, the stage 31 is moved in the X-axis direction, the Y-axis direction, and the θ direction that are parallel to the plate surface of the CF base board 11aM relative to the head 32. During the movement, the sealing material S is discharged by the dispenser 32a. As illustrated in FIG. 11, the sealing material S is disposed in line along the area of the CF base board 11aM to form the sealing member 11q. The sealing material S is selectively disposed in the area to form the sealing member 11q. In comparison to a configuration in which the sealing material S is disposed in an entire area within the plate surface of the CF board 11a and the sealing material S is selectively cured, the amount of sealing material S to be used is smaller. This is preferable for reducing the production cost. The sealing material S disposed on the CF base board 11aM is rolled and compressed by the first roller 32b that is disposed at the position closer to the CF base board 11aM. As a result, the sealing material S is ground. The sealing material S that is ground by the first roller 32b has the particle diameter equal to the cell gap or less as illustrated in FIG. 12 and spread in the width direction of the sealing member 11q (a first rolling and compressing process). As illustrated in FIG. 13, in the sealing material curing process that is included in the sealing member forming process, the laser beam that is output from the laser beam output port 32c is applied to the sealing material S that has been rolled and compressed by the first roller 32b. The nylon powder that is exit in the laser applied section is instantaneously heated and sintered. In sections of the sealing material to which the laser beam is not applied (non-laser applied sections), the nylon powder is not sintered and thus not cured. As illustrated in FIG. 14, the sealing material S to which the laser beam is applied is rolled and compressed by the second roller 32d that is disposed at the position closer to the CF base board 11aM (a second rolling and compressing process). The second roller 32d is heated by the heater and thus the sealing material S is softened. According to the configuration, the rolling and compressing can be accelerated while the flowability of the sealing material S is ensured. The sealing material S is spread by the second roller 32d to have a thickness that is about equal to the cell gap and cured without any uncured sections (completely cured). As a result, the sealing member 11q is formed. The above-described sealing member forming process is performed for every CF board 11a that is within the plate surface of the CF base board 11aM. As illustrated in FIG. 15, the sealing member 11q is formed on each CF board 11a.

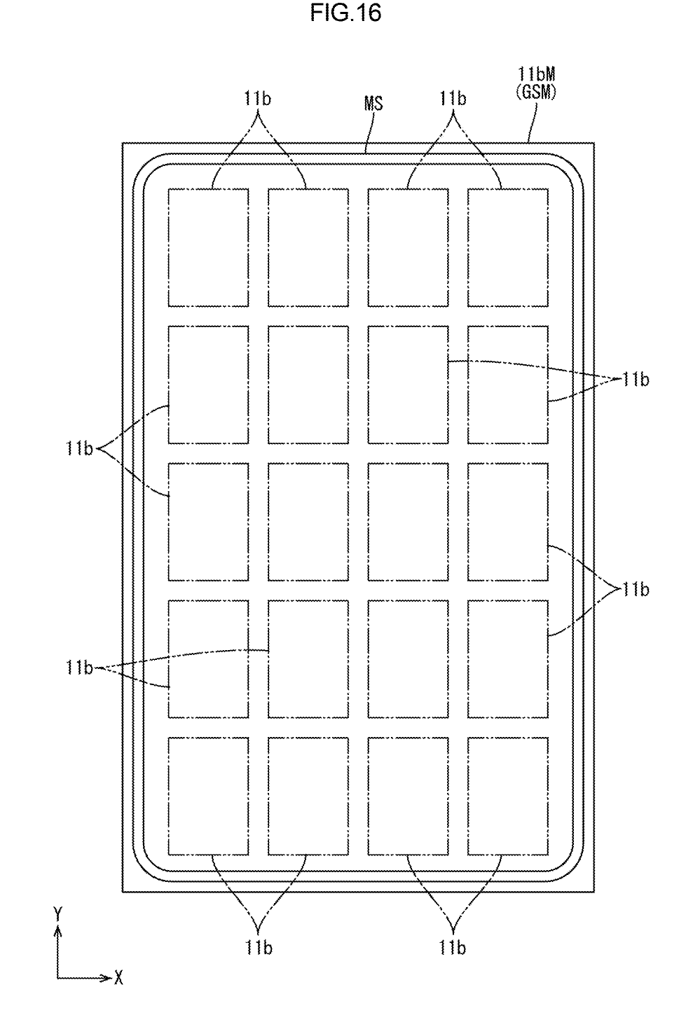

As illustrated in FIG. 16, in the base sealing material disposing process, the base sealing material MS that includes an uncured section is disposed on the array base board 11bM to collectively surround the array boards 11b. The base sealing material MS is disposed in an outer edge section of the array base board 11bM in a vertically-long frame shape in a plan view. The base sealing material MS is made of thermosetting resin material. When the base sealing material MS is heated to a predefined curing temperature, the base sealing material MS is cured and formed into the base sealing member 21. In the base sealing material disposing process, an interim curing processing is performed to heat the base sealing material MS for a short period of time to cure a surface thereof. Most of inner section of the base sealing material MS on which the interim curing processing has been performed is uncured although the surface of the base sealing material MS is cured. The base sealing material disposing process is performed on the array base board 11bM but not on the CF base board 11aM on which the sealing member forming process is performed. Therefore, the sealing member forming process and the base sealing material disposing process can be performed in parallel. In comparison to a method in which the sealing member forming process and the base sealing material disposing process area performed on the CF base board 11aM, the time required for producing the liquid crystal panel 11 can be reduced.

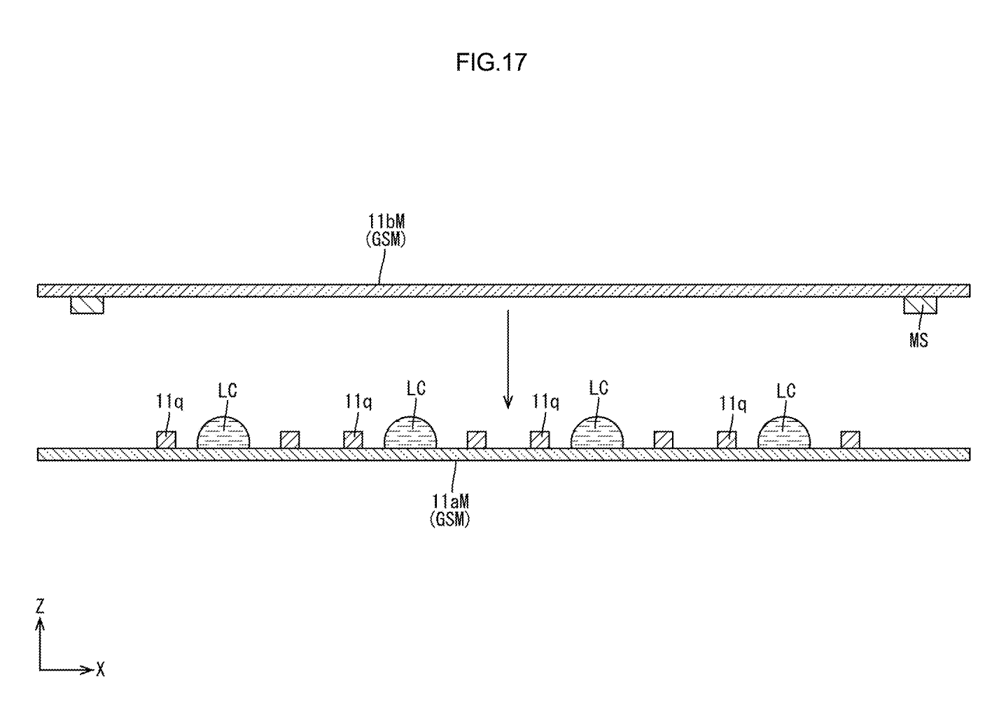

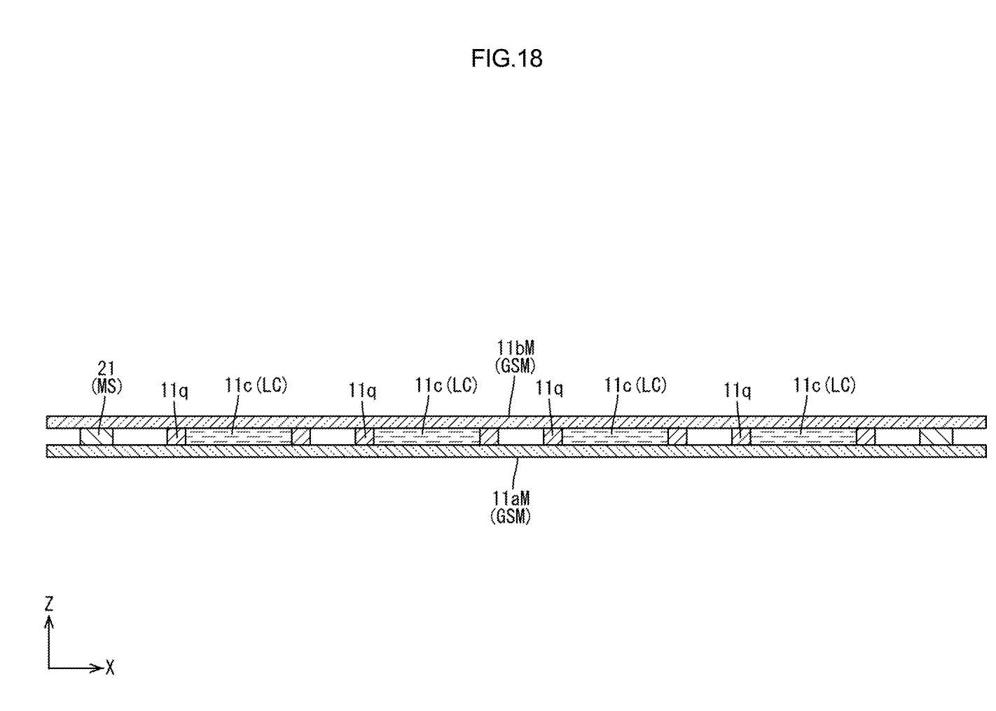

As illustrated in FIG. 17, in the board bonding process, a liquid crystal material LC is dropped into a section of each CF board 11a surrounded by the sealing member 11q on the CF base board 11aM and then the array base board 11bM is bonded to the CF base board 11aM. The board bonding process is performed in the vacuum environment. As illustrated in FIG. 18, when the base boards 11aM and 11bM are bonded together, the liquid crystal material LC to form the liquid crystal layer 11c is pressed and spread between the base boards 11aM and 11bM and thus a space surrounded by the sealing member 11q is filled with the liquid crystal material LC. The sealing member 11q receives a force that is applied by the liquid crystal layer 11c to squeeze the sealing member 11q. When the frame size is further reduced and the width of the sealing member 11q is reduced, the sealing member 11q may not be able to withstand the force and the liquid crystal layer 11c may partially enter the sealing member 11q. In the sealing member forming process that is performed prior to the board bonding process, the sealing material S is cured without any uncured sections (completely cured) and the sealing member 11q is formed. Even if the frame size is further reduced, the liquid crystal layer 11c is less likely to partially enter into the sealing member 11q. Because the entrance of the liquid crystal layer into the sealing member 11q is less likely to occur, a decrease in fixing strength of the sealing member 11q relative to the boards 11a and 11b is less likely to occur. Furthermore, the sealing member 11q is less likely to have bubbles and thus removal of the boards 11a and 11b is less likely to occur. Other than the above, when the width of the sealing member 11q is reduced according to the reduction in the frame size, external moisture may pass through the uncured section of the sealing member 11q and diffuse in the liquid crystal layer 11c. In the sealing member forming process that is performed prior to the board bonding process, the sealing material is cured without any uncured section (completely cured) and the sealing member 11q is formed. Even if the frame size is further reduced, the external moisture is less likely to pass through the sealing member 11q. Therefore, the moisture is less likely to diffuse in the liquid crystal layer 11c. When the board bonding process is performed, the base sealing material MS that includes the uncured sections tightly contact the CF base board 11aM. Therefore, a space between the base boards 11aM and 11bM is maintained under negative pressure. After the board bonding process that is performed in the vacuum environment is completed, the base boards 11aM and 11bM are placed in the atmospheric pressure environment. When the base boards 11aM and 11bM are placed in the atmospheric pressure environment, displacement or removal of the base boards 11aM and 11bM is less likely to occur.

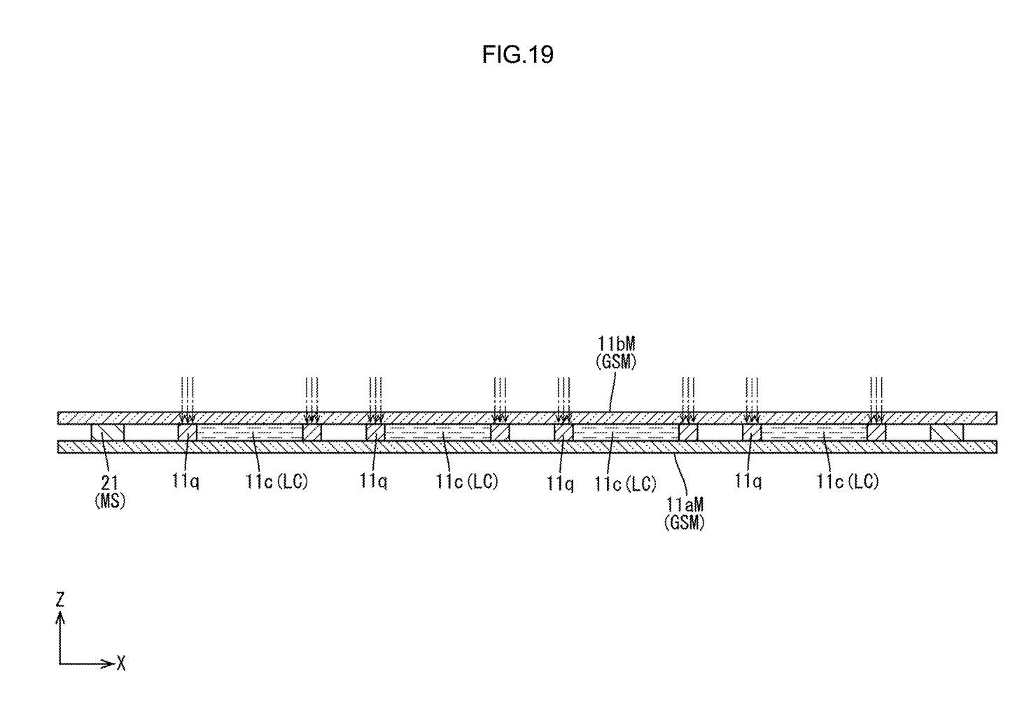

In the sealing member fixing process, the sealing member 11q is fixed to each array board 11b of the array base board 11bM of the bonded base boards 11aM and 11bM to seal the liquid crystal layer 11c. To fix the sealing member 11q to the array board 11b, as illustrated in FIG. 19, the laser beam is applied to the sealing member 11q from the CF board 11a side to melt a section of the sealing member 11q which contacts the CF board 11a. Immediately after that, the melted section of the sealing member 11q is cured and thus the sealing member 11q is fixed to the CF board 11a. The laser beam that is applied to the sealing member 11q is less likely to be blocked by the light blocking portion 11l because the sealing member 11q does not overlap the light blocking portion 11i of the CF board 11a and by the traces 20 of the array board 11b (see FIG. 7). Even if the frame size of the liquid crystal panel 11 is further reduced and the arrangement density of the traces 20 on the array board 11b is increased, that is, the intervals of the traces 20 are reduced, the fixation of the sealing member 11q to the CF board 11a can be properly improved regardless of the reduction in the intervals of the traces 20. In FIG. 19, the laser beams that are applied to the sealing members 11q in the sealing member fixing process are indicated with chain-line arrows. The laser beams may be separately applied to the sealing members 11q in sequence or collectively applied to all sealing members 11q at a time.

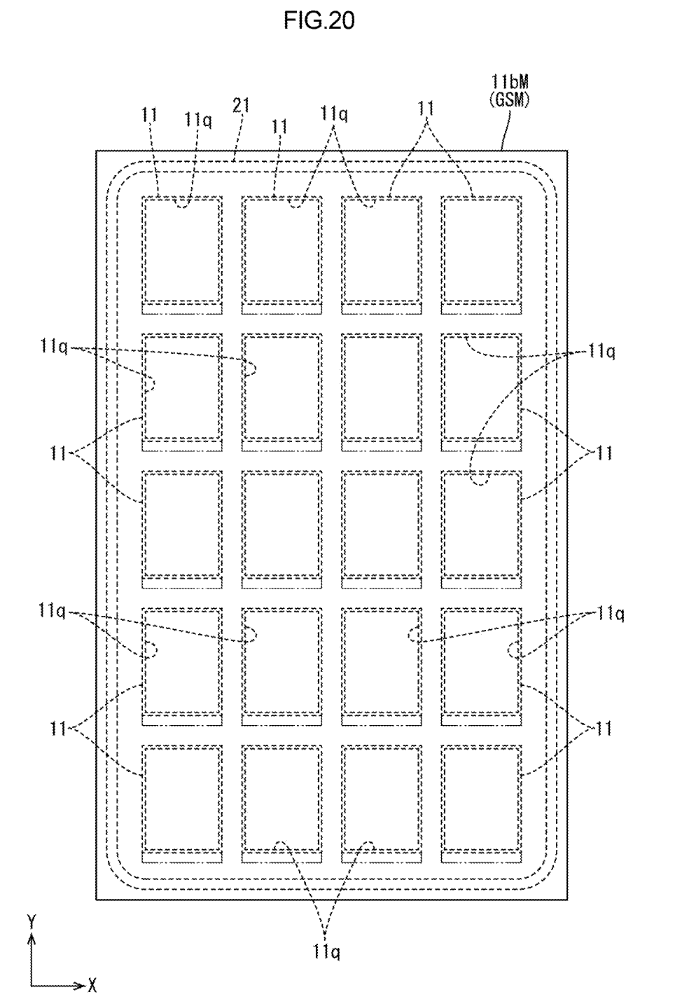

In the base sealing material curing process, the thermosetting resin material that is the base sealing material MS is heated to the curing temperature. Through the heating, the base sealing material MS is cured without any uncured sections (completely cured). As illustrated in FIG. 20, the base sealing member 21 is formed. In association with the heating, reorientation of the liquid crystal molecules that are included in the liquid crystal layer 11c is accelerated. Therefore, the liquid crystal molecules that are included in the liquid crystal layer 11c are properly orientated. The base sealing material curing process may be performed prior to the sealing member fixing process. In the cutting process, the base boards 11aM and 11bM are cut along a predefined scribe line to obtain the liquid crystal panel 11.

As described above, the method of producing the liquid crystal panel 11 in this embodiment (the display panel) includes the sealing member forming process, the board bonding process, and the sealing member fixing process. The sealing member forming process includes forming the sealing member 11q by curing the sealing material S disposed on the CF board 11a (the first board) without any uncured section. The board bonding process includes bonding the array board 11b (the second board) to the CF board 11a with the liquid crystal layer 11c (the medium layer) therebetween. The sealing member fixing process includes fixing the sealing member 11q to the array board 11b.

In the sealing member forming process, the sealing material S is disposed on the CF board 11a and the sealing material S is cured without any uncured sections. Through the process, the sealing member 11q is formed. In the board bonding process that is subsequently performed, the array board 11b is bonded to the CF board 11a with the liquid crystal layer 11c therebetween. In the sealing member fixing process that is subsequently performed, the sealing member 11q is fixed to the array board 11b. Through the process, the liquid crystal layer 11c is sealed. In the board bonding process, the liquid crystal layer 11c is pressed and spread between the boards 11a and 11b in association with bonding of the boards 11a and 11b. The sealing member 11q may receive the force that is applied by the liquid crystal layer 11c to squeeze the sealing member 11q. If the frame size is further reduced and the width of the sealing member 11q is reduced, the sealing member 11q may withstand the force and thus the liquid crystal layer 11c may partially enter into the sealing member 11q. In the sealing member forming process that is performed prior to the board bonding process, the sealing material S is cured without any uncured sections and the sealing member 11q is formed. Even if the frame size is further reduced, the liquid crystal layer 11c is less likely to partially enter into the sealing member 11q. If the width of the sealing member 11q is reduced when the frame size is further reduced, external moisture may pass through the uncured section of the sealing member 11q and diffuse in the liquid crystal layer 11c. In the sealing member forming process that is performed prior to the board bonding process, the sealing material S is cured without any uncured sections and the sealing member 11q is formed. Even if the frame size is further reduced, the external moisture is less likely to pass the sealing member 11q and thus the moisture is less likely to diffuse in the liquid crystal layer 11c. This is preferable for reducing the frame size of the liquid crystal panel 11.

The method of producing the liquid crystal panel 11 includes the CF base board producing process (the first base board producing process), the array base board producing process (the second base board producing process), the base sealing material disposing process, and the base sealing material curing process. The CF base board producing process includes producing the CF base board 11aM (the first base board) which includes the CF boards 11a within the plate surface. The array base board producing process includes producing the array base board 11bM (the second base board) which includes the array boards 11b within the plate surface. The base sealing material disposing process includes disposing the base sealing material MS that includes the uncured section on any one of the CF base board 11aM and the array base board 11bM to surround either the CF boards 11a or the array boards 11b. The base sealing material curing process is performed at least after the board bonding process for curing the base sealing material MS without any uncured sections to form the base sealing member 11q. In the base sealing material disposing process, the base sealing material MS that includes the uncured section is disposed on either the CF base board 11aM that is produced through the CF base board producing process or the array base board 11bM that is produced through the array base board producing process to surround either the CF boards 11a or the array boards 11b. When the CF base board 11aM and the array base board 11bM are bonded together in the board bonding process that is subsequently performed, the base sealing material MS that includes the uncured section closely contact the other one of the CF base board 11aM and the array base board 11bM. The space between the base boards 11aM and 11bM is maintained under the negative pressure. Therefore, the base boards 11aM and 11bM are less likely to be displaced or removed. In the base sealing material curing process that is subsequently performed, the base sealing material MS is cured without any uncured sections and the base sealing member 11q is formed.

In the base sealing material disposing process of the method of producing the liquid crystal panel 11, the base sealing material MS is disposed on the array base board 11bM. The base sealing material disposing process is performed to dispose the base sealing material MS on the array base board 11bM that is different from the CF base board 11aM on which the sealing material forming process is performed. According to the method, the sealing member forming process and the base sealing material disposing process can be performed in parallel. In comparison to a method in which the sealing member forming process and the base sealing material disposing process are performed on the CF base board 11aM, the time that is required for the production of the liquid crystal panel 11 can be reduced.

In the board bonding process of the method of producing the liquid crystal panel 11, the medium layer is the liquid crystal layer 11c. In the base sealing material disposing process, the thermosetting resin material is disposed for the base sealing material MS. In the base sealing material curing process, the heating is performed until the temperature reaches at least the curing temperature of the thermosetting resin material. When the heating is performed until the temperature reaches at least the curing temperature of the thermosetting resin material of the base sealing material MS in the base sealing material curing process, the thermosetting resin material is cured and the base sealing member 11q is formed. The reorientation of the liquid crystal molecules in the liquid crystal layer 11c that is the medium layer is accelerated. Therefore, the liquid crystal molecules in the liquid crystal layer 11c are properly orientated.

In the sealing member forming process of the method of producing the liquid crystal panel 11, the sealing material S is discharged by the dispenser 32a to dispose the sealing material S along the area to form the sealing member 11q. In comparison to a method in which the sealing material S is disposed over an entire are of the CF board 11a within the plate surface thereof and the sealing material S is selectively cured, the amount of the sealing material S to be used can be reduced. This method is preferable for reducing the production cost.

The sealing member forming process of the method of producing the liquid crystal panel 11 includes the sealing material disposing process and the sealing material curing process. The sealing material disposing process includes disposing the sealing material S that is in the powdered form on the CF board 11a. The sealing material curing process includes applying the laser beams to the sealing material S and selectively curing the sections to which the laser beams are applied without any uncured sections. In the sealing material disposing process, the sealing material S that is in the powdered form is disposed on the CF board 11a. In the sealing material curing process that is subsequently performed, the laser beams are applied to the sealing material S that is disposed on the CF board 11a and the sections to which the laser beams are applied are selectively cured without any uncured sections. Through the processes, the sealing member 11q is formed.

The liquid crystal panel 11 in this embodiment includes the array board 11b, the CF board 11a (the common board), the liquid crystal layer 11c, and the sealing member 11q. The array board 11b includes at least the pixels PX and the traces 20. The pixels PX are arranged in the matrix in the display area AA in which images are displayed. The traces 20 are disposed in the non-display area NAA outside the display area AA. The CF board 11a that includes the light blocking portion 11l is disposed opposite the array board 11b. The light blocking portion 11l include at least the sections that are disposed to separate the pixels PX from one another. The liquid crystal layer 11c is sandwiched between the array board 11b and the CF board 11a. The sealing member 11q is disposed between the array board 11b and the CF board 11a to surround the liquid crystal layer 11c and to overlap the traces 20 in the non-display area NAA. The sealing member 11q is made of the material that has the light blocking property and disposed not to overlap the light blocking portion 11l.

According to the configuration, the pixels PX that are arranged in the matrix in the display area AA are separated from one another by the light blocking portion 11l. Therefore, color mixture is less likely to occur. The liquid crystal layer 11c that is sandwiched between the array board 11b and the CF board 11a is surrounded and sealed by the sealing member 11q that is disposed in the non-display area and between the array board 11b and the CF board 11a.

The sealing member 11q is disposed in the non-display area to overlap the traces 20 that are included in the array board 11b. To accelerate the fixation of the sealing member 11q to the CF board 11a with light that is applied from the array board 11b side, the light may be blocked by the traces 20. If the arrangement density of the traces 20 is increased when the frame size is further reduced, the fixation of the sealing member 11q to the CF board 11a may become insufficient or takes a longer period of time. The sealing member 11q is disposed not to overlap the light blocking portion 11l that is includes in the CF board 11a. If light is applied to the sealing member 11q from the CF board 11a side to fix the sealing member 11q to the array board 11b, the light is less likely to be blocked by the light blocking portion 11l. Therefore, the fixation of the sealing member 11q can be properly accelerated. Even if the arrangement density of the traces 20 is increased when the frame size is further reduced, the fixation of the sealing member 11q to the array board 11b can be properly accelerated regardless of the arrangement density of the traces 20. Furthermore, the sealing member 11q has the light blocking property. Therefore, although the sealing member 11q is disposed not to overlap the light blocking portion 11l, light leakage is less likely to occur in the non-display area NAA. This configuration is preferable for reducing the frame size.

The CF board 11a of the liquid crystal panel 11 includes the planarization layer 11m that is disposed at least over the light blocking portion 11l on the liquid crystal layer 11c side. The planarization layer 11m is disposed in the area not to overlap the sealing member 11q. According to the configuration, the sealing member 11q is fixed to the CF board 11a with direct contact. Namely, because the planarization layer 11m is not disposed between the sealing member 11q and the CF board 11a, the sealing member 11q is more strongly fixed to the CF board 11a. Only the interface between the sealing member 11q and the CF board 11a is exposed to the outside. In comparison to a configuration in which the planarization layer 11m is disposed between the sealing member 11q and the CF board 11a, the area of the interface that is exposed to the outside can be reduced. Therefore, the external moisture is less likely to pass through the interface and enter into the liquid crystal layer 11c.

In the liquid crystal panel 11, the outer surface of the sealing member 11q on the opposite side from the liquid crystal layer 11c is flush with at least the end surface of the CF board 11a. In comparison to a configuration in which the outer surface of the sealing member 11q is located inner than the end surface of the CF board 11a, the frame size can be further reduced.

The sealing member 11q of the liquid crystal panel 11 is made of the synthetic resin material with the light blocking compounds mixed in the synthetic resin material. According to the configuration, the light blocking compounds can be easily dispersed in the synthetic resin material when mixing the light blocking compounds in the synthetic resin material. Therefore, the sealing member 11q that delivers even light blocking performance can be easily provided. In comparison to a configuration in which the sealing member 11q is made of metal, the sealing member 11q can be fixed to the CF board 11a with a lower temperature.

The sealing member 11q of the liquid crystal panel 11 contains the spacer particles. This configuration is preferable for maintaining the height of the sealing member 11q constant.

### Second Embodiment

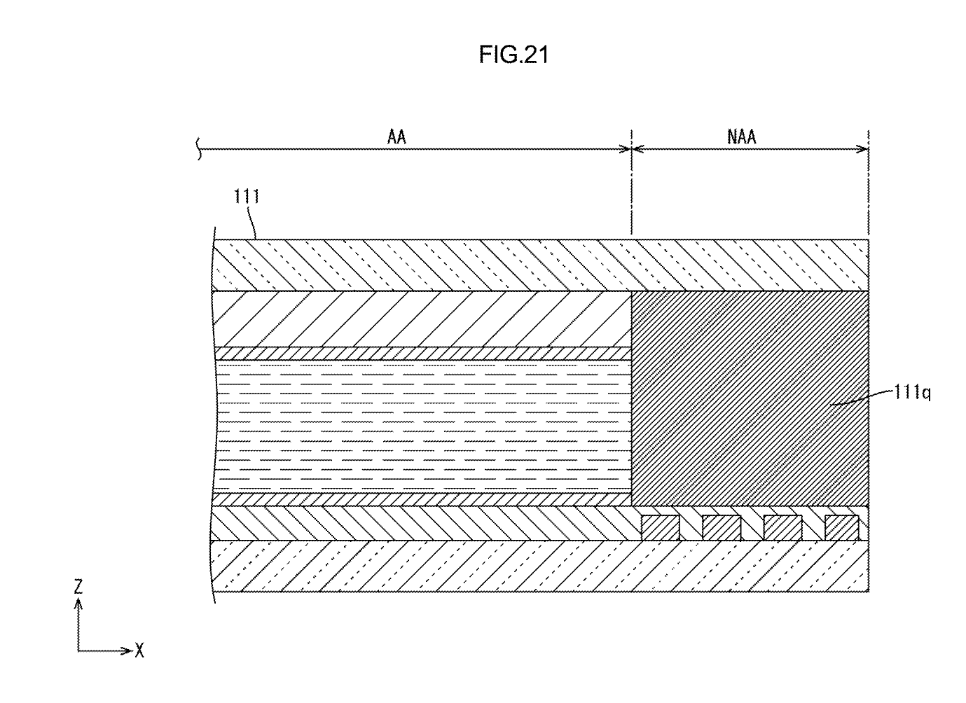

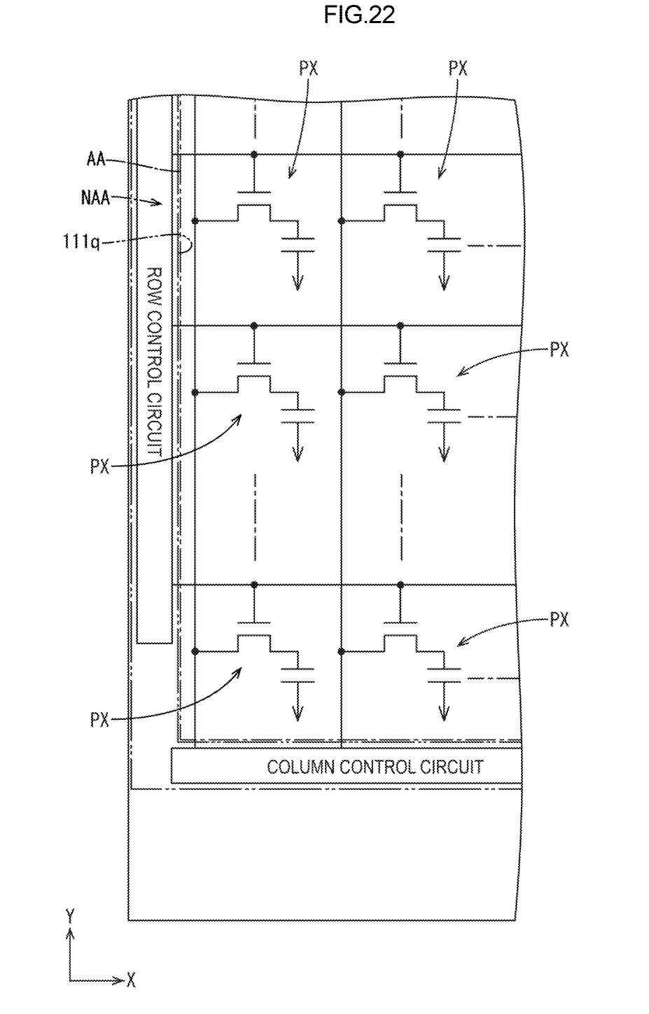

A second embodiment of the present invention will be described with reference to FIGS. 21 and 22. The second embodiment includes a light blocking portion without a frame section. Configurations, functions, and effects similar to those of the first embodiment will not be described.

As illustrated in FIGS. 21 and 22, a liquid crystal panel 111 in this embodiment includes a sealing member 111q that is disposed for about entire width of the non-display area NAA. The light blocking portion, which is not illustrated, does not include the frame section. The sealing member 111q is disposed to separate the pixels PX from one another together with a grid section of the light blocking portion. The pixels PX that are disposed at the outermost among the pixels PX that are arranged in the matrix in the display area AA are separated by the outermost section of the grid section of the light blocking portion and the sealing member 111q that collectively surrounds them. Because the frame section is not included in the light blocking portion, the frame size of the liquid crystal panel 111 can be further reduced.

As described above, in the liquid crystal panel 111 in this embodiment, the sealing member 111q is disposed to separate the pixels PX from one another together with the light blocking portion. In comparison to a configuration in which the light blocking portion includes the frame section along the sealing member 111q and the pixels PX are separated from one another only by the light blocking portion, this configuration is more preferable for reducing the frame size.

### Third Embodiment

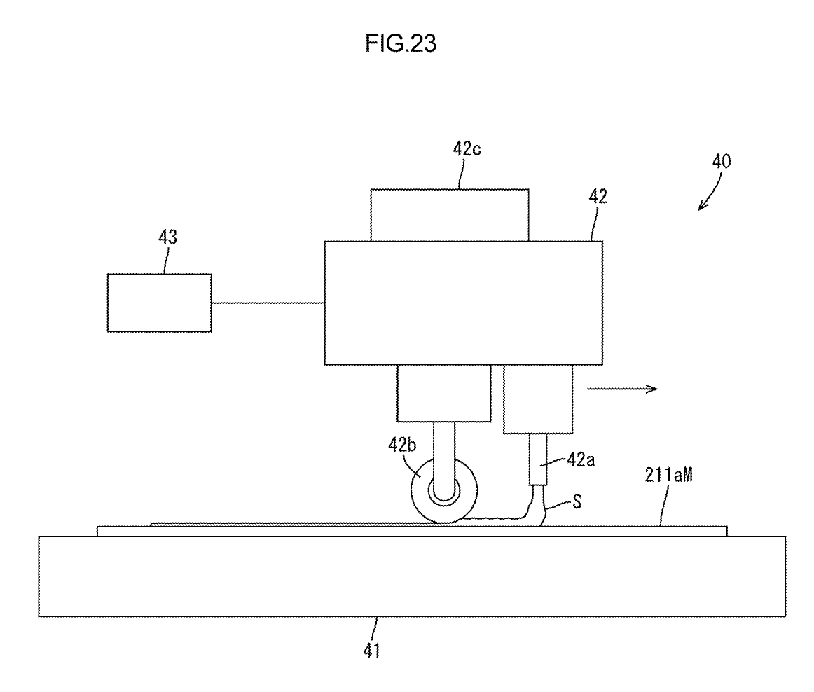

A third embodiment of the present invention will be described with reference to FIG. 23. The third embodiment includes a sealing member forming device 40 used in a sealing member forming process, which is different from the first embodiment. Configurations, functions, and effects similar to those of the first embodiment will not be described.

As illustrated in FIG. 23, in the sealing member forming process in this embodiment, the fusion deposition type sealing member forming device 40 is used. The sealing member forming device 40 includes at least a stage 41, a head 42, and a controller 43. A CF base board 211aM is placed on the stage 41. The head 42 is disposed opposite the CF base board 211aM on the stage 41. The controller 43 is connected to the head 42 and configured to control the head 42. In comparison to the powder sintering type sealing member forming device 30 in the first embodiment (see FIG. 10), the fusion deposition type sealing member forming device 40 is provided with a lower facility cost because it does not include the light source 33 and the laser beam output port 32c. A major different of the sealing member forming device 90 from the sealing member forming device 30 in the first embodiment is the head 42. Therefore, the head 42 will be described in detail and other configurations similar to those of the first embodiment will not be described.

The head 42 of the sealing member forming device 40 includes at least a dispenser 42a, a roller 42b, and a driver 42c. The dispenser 42a is configured to fuse the thermosetting resin material of the sealing material S (thermal fusion) and to discharge the sealing material S onto the CF base board 211aM. The roller 42b is configured to roll and compress the sealing material that is discharged by the dispenser 42a. The driver 42c is configured to drive the dispenser 42a and the roller 42b. The dispenser 42a includes a syringe and a heater. The syringe is filled with the thermosetting resin material of the sealing material S such as an ABS resin material and a nylon resin material. The heater is configured to heat the syringe to fuse the thermosetting resin material. It is preferable to add one to some percent of silica beads that have particle diameters about equal to the cell gap to the thermosetting resin material as spacer particles. The amount of the sealing material S that is discharged by the dispenser 42a is controlled by the driver 42c.

The roller 42b can be move down to be closer to the CF base board 211aM and up to be away from the CF base board 211aM by the driver 42c. Specifically, the roller 42b is set at a position away from the CF base board 211aM when the sealing material S is not discharged by the dispenser 42a and at a position closer to the CF base board 211aM when the sealing material S is discharged by the dispenser 42a. The roller 42b is configured to press and spread the sealing material S that is fused on the CF base board 211aM until the thickness of the sealing material S becomes about equal to the cell gap. The sealing material S that is pressed and spread by the roller 42b is cured without any uncured sections (completely cured) as the temperature decreases (cool down) and the sealing member is formed. The sealing member that is formed as described above is fixed to an array base board, which is not illustrated, through pressing and heating of the base boards 211aM in a sealing material fixing process that is performed after a board bonding process. It is preferable that the roller 42b or the stage 41 includes a heater to maintain flowability of the sealing material S before the rolling and the compression of the sealing material S that is discharged onto the CF base board 211aM by the dispenser 42a by the roller 42b starts.

As described above, according to the method of producing the liquid crystal panel in this embodiment, the sealing material S that is the thermosetting resin material is heated and fused, applied to the CF base board 211aM (the CF board), and cured without any uncured sections in the sealing member forming process. In the sealing member forming process, after the sealing material S that is the thermosetting resin material is heated and fused, the fused sealing material S is applied to the CF base board 211aM. The sealing material S that is applied to the CF base board 211aM is cured without any uncured sections as the temperature decreases. Through the process, the sealing member is formed.

### Fourth Embodiment

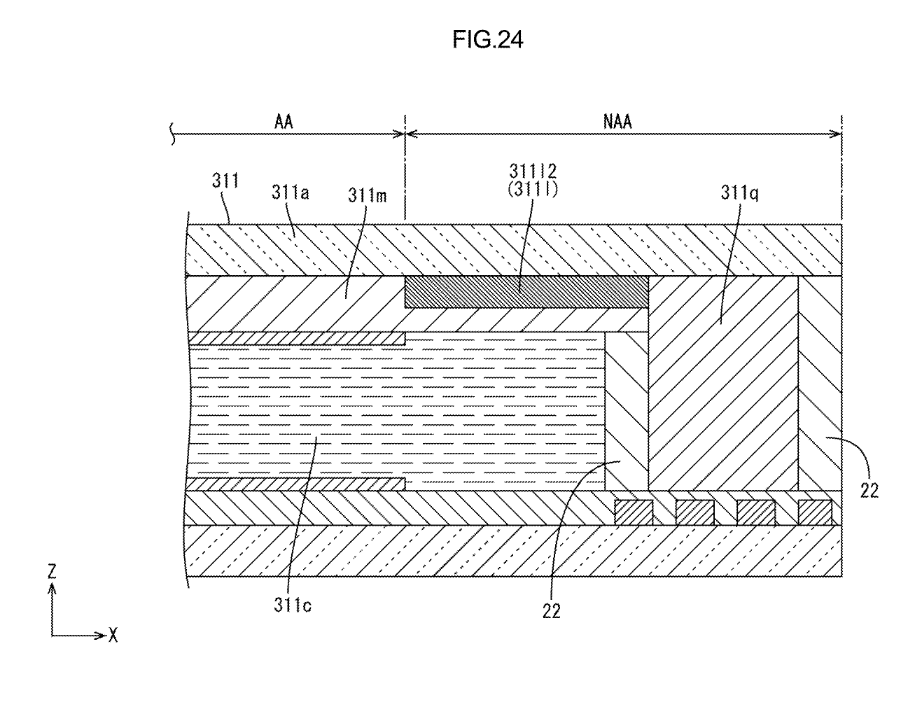

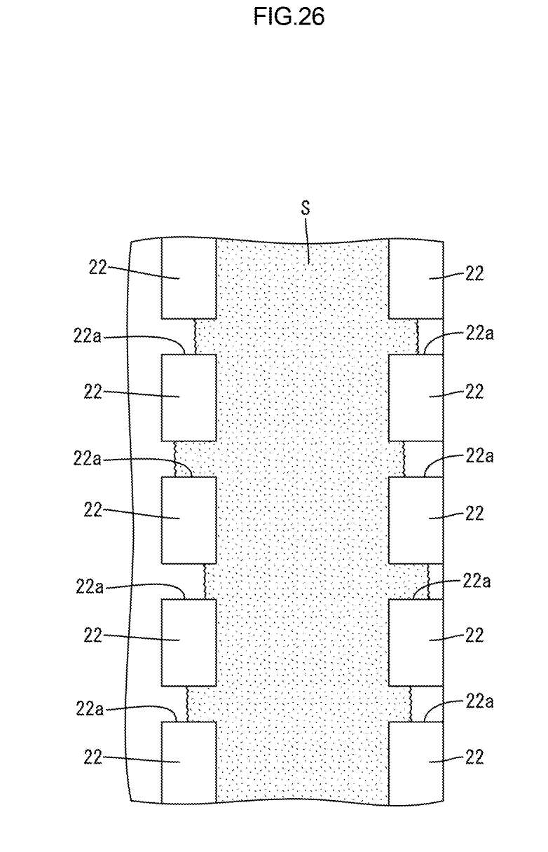

A fourth embodiment will be described with reference to FIGS. 24 to 26. The fourth embodiment includes sealing member control portions 22 to control a width of a sealing member 311q, which is different from the first embodiment. Configurations, functions, and effects similar to those of the first embodiment will not be described.

As illustrated in FIG. 24, a liquid crystal panel 311 in this embodiment includes the sealing member control portions 22. The sealing member control portions 22 are disposed to sandwich the sealing member 311q from an inner side (a liquid crystal layer 311c side) and an outer side (an opposite side from the liquid crystal layer 311c side). The sealing member control portions 22 extend along the sealing member 311q (parallel to the sealing member 311q) to form a frame shape in a plan view. One of the sealing member control portions 22 is disposed adjacent to the sealing member 311q on the inner side. The other sealing member control portion 22 is disposed adjacent to the sealing member 311q on the outer side. With the sealing member control portions 22, the width of the sealing member 311q can be controlled constant. The sealing member control portions 22 have widths in a range from 20 to 50 μm, which are smaller than the width of the sealing member 311q. When a CF board 311a is produced, that is, in the CF base board producing process, the sealing member control portions 22 are formed during formation of photo spacers on a surface of a planarization layer 311m. The sealing member control portions 22 are made of the same material as that of the photo spacers. It is preferable that the sealing member control portion 22 adjacent to the sealing member 311q on the inner side is disposed to overlap a frame section 311l2 of a light blocking portion 311l and the planarization layer 311m in a plan view.

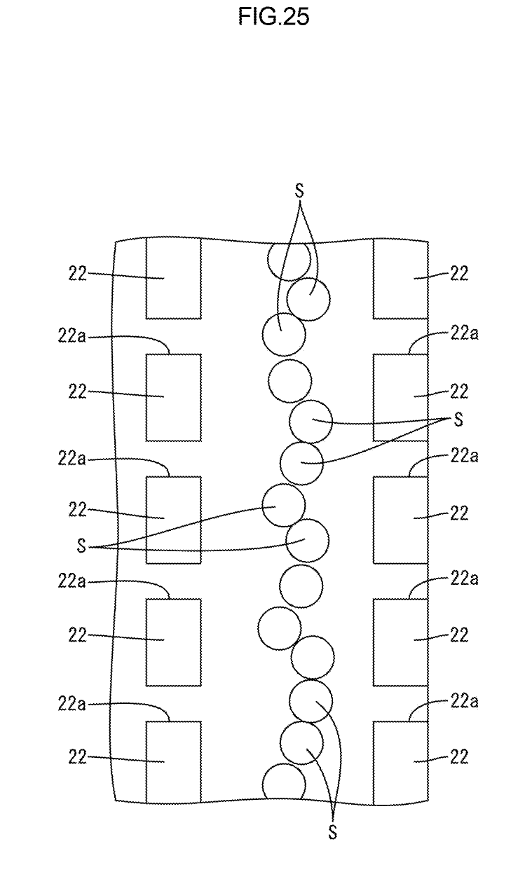

The sealing member control portions 22 fulfills its function in the sealing member forming process that is performed after the CF base board producing process. In a sealing material disposing process that is included in the sealing member forming process, when the sealing material S is discharged onto the CF board 311a by the dispenser (see FIGS. 10 and 11) of the sealing member forming device, the sealing material S is disposed in line in an area between the sealing member control portions 22 as illustrated in FIG. 25. The sealing member control portions 22 include holes 22a in the middle with respect to the extending direction thereof. The holes 22a are through holes that extend in the width direction of the sealing member control portions 22. An opening width of each hole 22a is smaller than the particle diameter (e.g., 50 μm) of the nylon powder in the sealing material S. The sealing material S that is disposed in the area between the sealing member control portions 22 cannot pass through the holes 22a of the sealing member control portions 22 and thus remain in the area between the sealing member control portions 22. The sealing material S that is disposed as described above are rolled and compressed by the first roller (see FIGS. 10 and 12) of the sealing member forming device. As a result, the sealing material S are ground and pressed to spread. An area in which the sealing material S is pressed to spread tends to depend on distribution density of the nylon powder that is disposed in the sealing material disposing process. If the distribution density of the nylon powder is high at a point, the area in which the sealing material S is pressed to spread may become locally large at the high distribution density point. In such a case, the area in which the sealing material S is pressed to spread is controlled by the sealing member control portions 22 that are disposed to sandwich the sealing material S. Therefore, the width of the sealing member 311q that is formed through the sealing material curing process is substantially constant for the entire length. If the distribution density of the nylon powder is high at a point, an excess of the sealing material S which may be produced during the rolling and the compressing of the sealing material S is released to the outside through the holes 22a of the sealing member control portions 22. Therefore, unevenness in height of the sealing member 311q resulting from the excess of the sealing material S is less likely to occur.

As described above, the liquid crystal panel 311 in this embodiment includes the sealing member control portions 22 that are disposed to sandwich the sealing member 311q from the liquid crystal layer 311c side and from the opposite side from the liquid crystal layer 311c. With the sealing member control portions 22, the width of the sealing member 311q can be controlled during the formation of the sealing member 311q. Therefore, the frame width of the liquid crystal panel 311 can be set with high accuracy. This configuration is preferable for reducing the frame size.

The sealing member control portions 22 of the liquid crystal panel 311 extend parallel to the sealing member 311q and include the holes 22a in the middle. According to the configuration, an uncured material can be released through the holes 22a of the sealing member control portions 22 during the formation of the sealing member 311q. Therefore, the sealing member 311q has the constant height.

### Other Embodiments

The present invention is not limited to the above embodiments described in the above sections and the drawings. For example, the following embodiments may be included in technical scopes of the present invention.

(1) In each of the above embodiment sections, the method of producing the liquid crystal panel that includes the sealing member that is disposed not to overlap the light blocking portion and has the light blocking property is described. According to the method, the board bonding process is performed after the sealing member forming process in which the sealing material is cured without any uncured sections to form the sealing member. Then, the sealing material fixing process is performed to fix the sealing member to the array board. However, the method of producing the liquid crystal panel may be modified. For example, the board bonding process may be performed after a sealing material temporarily curing process in which the sealing material is temporarily cured similar to the know method. Then, a sealing material permanently curing process may be performed to permanently cure the sealing material. Alternatively, the configuration of the liquid crystal panel may be modified. For example, the sealing member may not have the light blocking property similar to the known configuration and may be disposed to overlap the light blocking portion.

(2) in each of the above embodiments, the nylon powder that contains nylon (polyamide) is used for the main component of the sealing material. However, a material other than nylon may be used. Examples of the main component of the sealing material include a polyarnide resin hot-melt adhesive (an adhesive that contains a polyamide (nylon) resin as a main component), polypropylene (PP), polylactic acid, polyethylene (PE), polyethylene terephthalate (PET), polystyrene (PS), acrylonitrile butadiene styrene copolymer (ABS), ethylene vinyl acetate copolymer (EVA), styrene acrylonitrile copolymer (SAN), and polycaprolactone.

(3) In each of the above embodiments, the sealing material is the synthetic resin material. However, the sealing material may be a metal material. The metal material may be titanium particles made of titanium.

(4) in the first embodiment, the carbon dioxide laser beams are used for curing the sealing material. However, gas laser beams other than the carbon dioxide laser beams may be used. Examples of the gas laser beams include excimer laser beams (ArF, KrF, XeCl, or XeF may be used as a medium), ion laser beams (argon ions, krypton ions, or mixture of those may be used as a medium), nitrogen laser beams that include nitrogen as a medium, mixed gas laser beams (mixed gas such as He—Ne and TEA-CO₂ is used as a medium), metal vapor laser beams (Cu or He—Cd may be used as a medium), and chemical laser beams (HF may be used as a medium). For the excimer laser beams, if ArF is used as a medium, it is preferable to use excimer laser beams with a wavelength of 193 nm and a radiation intensity of 500 mJ. If KrF is used as a medium, it is preferable to use excimer laser beams with a wavelength of 248 nm and a radiation intensity of 1 J.

(5) Other than the gas laser beams described in the above (4), solid-state laser beams or liquid laser beams may be sued for curing the sealing material. Examples of the solid-state laser beams include YAG laser beams (Nd³⁺:Y₃Al₃O₁₂ may be used as a medium), Q-switched YAG laser beams, ruby laser beams (Cr³⁺:Al₂O₃ may be used as a medium), glass laser beams, titanium sapphire laser beams (Ti⁴⁺:Al₂O₃ may be used as a medium), alexandrite laser beams (Cr³⁺:BeAl₂O₄ may be used as a medium), YLF laser beams (Er³⁺:YLi may be used as a medium), and semiconductor laser beams (GaAlAs or GaAlAs array may be used as a medium). For the semiconductor laser beams, if GaAlAs is used as a medium, it is preferable to use semiconductor beams with a wavelength of 750 to 905 nm and radiation intensity of 1 W.

(6) In each of the above embodiments, the sealing material is sintered and cured by the laser beams (powder sintering) or the thermosetting resin material used for the sealing material is cooled and cured after fusion through heating (thermal dissolution). However, an ultraviolet curable resin material may be used for the sealing material and cured with ultraviolet rays. In this case, the ultraviolet curable resin material may be applied to a target board with an ink-jet technology.

(7) Other than the above (6), powder adhesion may be used. Powder such as gypsum may be used for the sealing material. The powered may be disposed on a target board and a binder such as an adhesive may be sprayed to the powder to cure the powder.

(8) In each of the above embodiments, the sealing member is formed on the CF board (the CF base board) in the sealing member forming process, and the sealing member is fixed to the array board (the array base board) in the sealing member fixing process. However, the sealing member may be formed on the array board (the array base board) in the sealing member forming process and the sealing member may be fixed to the CF board (the CF base board) in the sealing member fixing process.

(9) In each of the above embodiments, the base sealing member is disposed in the array board (the array base board) in the base sealing material disposing process. However, the base sealing member may be disposed on the CF board (the CF base board) in the base sealing material disposing process.

(10) In each of the above embodiments, the base sealing member is formed. However, the base sealing member may be omitted if the base boards are fixed together with other methods. For example, ultraviolet curable resin materials may be disposed in the edge area of either one of the base boards in dots at intervals along the sealing member, the boards may be bonded together, and the ultraviolet resin materials in dots may be fixed through application of ultraviolet rays.

(11) In each of the above embodiments, the sealing member is disposed to overlap the row control circuit and the column control circuit for the entire areas. However, the sealing member may partially overlap the row control circuit and the column control circuit.

(12) In each of the above embodiments, the sealing member overlaps the row control circuit and the column control circuit. However, the sealing member may be disposed to overlap the traces other than the row control circuit and the column control circuit.

(13) In each of the above embodiment sections, the liquid crystal panel that includes the row control circuit and the column control circuit (the monolithic circuits) and the method of producing the liquid crystal panel are described. However, the present invention can be applied to a liquid crystal panel that includes only one of the row control circuit and the column control circuit or do not include the row control circuit and the column control circuit and to a method of producing the liquid crystal panel.

(14) In each of the above embodiment sections, the liquid crystal panel having the rectangular plan-view shape and the method of producing the liquid crystal panel are described. However, the present invention may be applied to liquid crystal panels having a square plan-view shape, a round plan-view shape, and an oval plan-view shape and methods of producing the liquid crystal panels.

(15) In each of the above embodiments, the driver is COG-mounted on the array board of the liquid crystal panel. However, the driver may be chip-on-film (COF) mounted on the liquid crystal panel flexible circuit board.

(16) In each of the above embodiments, the semiconductor film of the channels of the TFT is made of the oxide semiconductor material. Other than that, continuous grain (OG) silicon, which is one kind of polysilicon or amorphous silicon may be used as a material for the semiconductor film.

(17) in each of the above embodiment sections, the liquid crystal panel that is configured to operate in FFS mode and the method of producing such a liquid crystal panel are described. However, the present invention may be applied to liquid crystal panels that are configured to operate in VA mode, IPS mode, and TN mode, respectively, and to methods of producing those liquid crystal panels.

(18) In each of the above embodiments, the color filters of the liquid crystal panel have the three-color configuration of red, green, and blue. However, the present invention may be applied to color filters have a four-color configuration including yellow color portions in addition to the red, the green, and the blue color portions.

(19) In each of the above embodiment sections, the liquid crystal panel in the size that is classified into small size or small-to-medium size is described. However, the present invention may be applied to a liquid crystal panel in medium size or large size (or extra-large size) having a screen size of 20 to 100 inches. In such a case, the liquid crystal panel may be used for an electronic device such as a television device, an electronic signboard (a digital signage), and an electrical blackboard.

(20) In each of the above embodiment sections, the liquid crystal panel that includes the liquid crystal layer that is sandwiched between the boards is described. However, the present invention may be applied to a display panel that includes functional organic molecules other than the liquid crystals sandwiched between the boards.

(21) In each of the above embodiment sections, the liquid crystal panel and the method of producing the liquid crystal panel are described. However, the present invention can be applied to an organic EL panel and a method of producing the organic EL panel. In the organic EL panel, a dehumidification member or air may be included as a medium layer inside a sealing member. When the dehumidification member or the air is pushed into the sealing member because of pressure that may be produced during bonding of the boards, the dehumidification member or the air may enter the sealing member. According to the present invention, such a problem, that is, the entrance of the dehumidification member or the air into the sealing member can be solved.

(22) In each of the above embodiments, the TFTs are used as the switching components of the liquid crystal panel. However, the present invention may be applied to a liquid crystal panel that includes switching components other than TFTs (e.g., thin film diodes (TFD)). The present invention may be applied to a liquid crystal panel that is configured to display black-and-white images other than the liquid crystal panel that is configured to display color images and a method of producing the liquid crystal panel.

### EXPLANATION OF SYMBOLS

11, 111, 311: Liquid crystal panel (Display panel)

11a, 311a: CF board (First board, Counter board)

11aM, 211aM: CF base board (First base board)

11b: Array board (Second board)

11bM: Array base board (Second base board)

11c, 311c: Liquid crystal layer (Medium layer)

11l, 311l: Light blocking portion

11m, 311m: Planarization layer

11q, 111q, 311q: Sealing member

20: Trace

21: Base sealing member

22: Sealing member control portion

22a: Hole

32a: Dispenser

42a: Dispenser

AA: Display area

MS: Base sealing material

NAA: Non-display area

PX: Pixel

S: Sealing material

1. A method of producing a display panel, the method comprising:
a sealing member forming process of forming a sealing member, the sealing member forming process including disposing a sealing material on a first board and curing the sealing material without any uncured section;
a board bonding process of bonding a second board to the first board with a medium layer between the first board and the second board; and
a sealing member fixing process of fixing the sealing member to the second board.

2. The method of producing a display panel according to claim 1, further comprising:
a first base board producing process of producing a first base board including a plurality of first boards within a plate surface of the first base board;
a second base board producing process of producing a second base board including a plurality of second boards within a plate surface of the second base board;
a base sealing material disposing process of disposing a base sealing material on any one of the first base board and the second base board to surround either the plurality of first boards or the plurality of second boards and to include an uncured section; and
a base sealing material curing process of curing the base sealing material without any uncured section to form a base sealing member, the base sealing material curing process being performed after at least the board bonding process.

3. The method of producing a display panel according to claim 2, wherein the base sealing material disposing process includes disposing the base sealing material on the second base board.

4. The method of producing a display panel according to claim 2, wherein
the medium layer in the board bonding process is a liquid crystal layer,
the base sealing material disposing process includes disposing a thermosetting resin material as the base sealing material, and
the base sealing curing process includes heating processing performed until a temperature reaches at least a curing temperature of the thermosetting resin material.

5. The method of producing a display panel according to claim 1, wherein the sealing member forming process includes discharging the sealing material by a dispenser and disposing the sealing material along an area to form the sealing member.

6. The method of producing a display panel according to claim 1, wherein
the sealing member forming process includes:
a sealing material disposing process of disposing the sealing material in a powdered form on the first board; and
a sealing material curing process of applying a laser beam to a section of the sealing material and selectively curing the section of the sealing material without any cured area.

7. The method of producing a display panel according to claim 1, wherein the sealing member forming process includes heating and fusing the sealing material that is the thermosetting resin material, applying the sealing material to the first board, and curing the sealing material without any uncured section.

8. A display panel comprising:
a plurality of pixels arranged in a matrix in a display area in which an image is displayed;
an array board including at least a plurality of traces disposed in a non-display area outside the display area;
a common board disposed opposite the array board, the common board including a light blocking portion including sections disposed to separate at least the plurality of pixels from one another;
a medium layer sandwiched between the array board and the common board; and
a sealing member disposed between the array board and the common board to overlap the plurality of traces in the non-display area to surround the medium layer, the sealing member being made of a material having a light blocking property and disposed not to overlap the light blocking portion.

9. The display panel according to claim 8, wherein the common board includes a planarization layer layered on a medium layer side relative to the light blocking portion, the planarization layer being disposed in an area not to overlap the sealing member.

10. The display panel according to claim 9, wherein the sealing member includes an outer surface on an opposite side from the medium layer side, the outer surface being flush with at least an end surface of the common board.

11. The display panel according to claim 8, wherein the sealing member is made of synthetic resin material with light blocking compounds contained in the synthetic resin material.

12. The display panel according to claim 8, further comprising sealing member control portions disposed to sandwich the sealing member from the medium layer side and an opposite side from the medium layer side.

13. The display panel according to claim 12, wherein the sealing member control portions extend parallel to the sealing member and include holes in the middle.

14. The display panel according to claim 8, wherein the sealing member contains spacer particles.

15. The display panel according to claim 8, wherein the sealing member is disposed to separate the plurality of pixels from one another together with the light blocking portion.
